(19) United States
(12) Patent Application Publication
(10) Pub. No.: US 2025/0112906 A1
(43) Pub. Date: Apr. 3, 2025

(54) DYNAMIC CONTROL PLANE FOR CONFIGURING CAPABILITIES ACROSS APPLICATIONS VIA A CLOUD PLATFORM

(71) Applicant: Okta, Inc., San Francisco, CA (US)

(72) Inventors: George Kwon, San Francisco, CA (US); Karl McGuinness, Oakland, CA (US); Damian Ezequiel Schenkelman, Buenos Aires City (AR)

(21) Appl. No.: 18/479,791

(22) Filed: Oct. 2, 2023

(51) Int. Cl. H04L 9/40

(52) U.S. Cl. CPC H04L 63/0815

(57) ABSTRACT

A platform determines first information for an application in accordance with a specification template that is common to multiple applications. The first information is usable by the platform for configuring and managing capabilities via the platform. The platform obtains second information that includes a first request to configure the application for an account of the user and a second request to configure a capability of the application. The platform redirects the user to authenticate for access to the application. The platform obtains a credential to authenticate with one or more APIs related to the application. The credential is associated with permissions that enable the platform to configure and manage the capability of the application via a provider. The platform configures the capability in the application via API calls from the platform to one or more endpoints of the provider. The API calls are authenticated via the credential.

### FIELD OF TECHNOLOGY

The present disclosure relates generally to identity management, and more specifically to a dynamic control plane for configuring capabilities across applications via a cloud platform.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

### SUMMARY

The described techniques relate to improved methods, systems, devices, and apparatuses that support a dynamic control plane for configuring capabilities across applications via a cloud platform. For example, such techniques may provide a framework for configuring and managing applications from a cloud platform over a duration of time. In some examples, the cloud platform may determine first information for an application associated with various capabilities. The first information may be determined at the cloud platform in accordance with an application specification template that is common to multiple applications. Additionally, the first information is usable by the cloud platform for configuring and managing the plurality of capabilities via the cloud platform. The cloud platform may also obtain second information from a first user of the cloud platform. The second information may include a first request to configure the application for an account of the application that is associated with the first user and a second request to configure a set of capabilities of the application. The set of capabilities selected from among the various capabilities of the application. The cloud platform may redirect the first user to authenticate the first user to obtain access to the application in accordance with an authentication flow for the application. In response to redirecting the first user, the cloud platform may obtain third information. The third information may include a credential to authenticate with one or more application programming interfaces (APIs) related to the application. The API credential is associated with one or more permissions that enable the cloud platform to configure and manage the set of capabilities of the application for the account via a provider of the application.

A method for configuring and managing applications from a cloud platform over a duration of time by an apparatus is described. The method may include determining first information for an application associated with a set of multiple capabilities, where the first information is determined in accordance with an application specification template that is common to a set of multiple applications, and where the first information is usable by the cloud platform for configuring and managing the set of multiple capabilities via the cloud platform, obtaining second information from a first user of the cloud platform, where the second information includes a first request to configure the application for an account of the application that is associated with the first user, and includes a second request to configure a set of capabilities of the application, the set of capabilities selected from among the set of multiple capabilities, redirecting the first user to authenticate the first user to obtain access to the application in accordance with an authentication flow for the application, obtaining third information in response to redirecting the first user, where the third information includes a credential to authenticate with one or more APIs related to the application, where the credential is associated with one or more permissions that enable the cloud platform to configure and manage the set of capabilities of the application for the account via the provider, and configuring the set of capabilities in the application via one or more API calls from the cloud platform to one or more endpoints of the provider, where the one or more API calls are authenticated via the API credential in accordance with the first information.

An apparatus for configuring and managing applications from a cloud platform over a duration of time is described. The apparatus may include one or more memories storing processor executable code, and one or more processors coupled with the one or more memories. The one or more processors may individually or collectively operable to execute the code to cause the apparatus to determine first information for an application associated with a set of multiple capabilities, where the first information is determined in accordance with an application specification template that is common to a set of multiple applications, and where the first information is usable by the cloud platform for configuring and managing the set of multiple capabilities via the cloud platform, obtain second information from a first user of the cloud platform, where the second information includes a first request to configure the application for an account of the application that is associated with the first user, and includes a second request to configure a set of capabilities of the application, the set of capabilities selected from among the set of multiple capabilities, redirect the first user to authenticate the first user to obtain access to the application in accordance with an authentication flow for the application, obtain third information in response to redirecting the first user, where the third information includes a credential to authenticate with one or more APIs related to the application, where the credential is associated with one or more permissions that enable the cloud platform to configure and manage the set of capabilities of the application for the account via the provider, and configure the set of capabilities in the application via one or more API calls from the cloud platform to one or more endpoints of the provider, where the one or more API calls are authenticated via the API credential in accordance with the first information.

Another apparatus for configuring and managing applications from a cloud platform over a duration of time is described. The apparatus may include means for determining first information for an application associated with a set of multiple capabilities, where the first information is determined in accordance with an application specification template that is common to a set of multiple applications, and where the first information is usable by the cloud platform for configuring and managing the set of multiple capabilities via the cloud platform, means for obtaining second information from a first user of the cloud platform, where the second information includes a first request to configure the application for an account of the application that is associated with the first user, and includes a second request to configure a set of capabilities of the application, the set of capabilities selected from among the set of multiple capabilities, means for redirecting the first user to authenticate the first user to obtain access to the application in accordance with an authentication flow for the application, means for obtaining third information in response to redirecting the first user, where the third information includes a credential to authenticate with one or more APIs related to the application, where the credential is associated with one or more permissions that enable the cloud platform to configure and manage the set of capabilities of the application for the account via the provider, and means for configuring the set of capabilities in the application via one or more API calls from the cloud platform to one or more endpoints of the provider, where the one or more API calls are authenticated via the API credential in accordance with the first information.

A non-transitory computer-readable medium storing code for configuring and managing applications from a cloud platform over a duration of time is described. The code may include instructions executable by a processor to determine first information for an application associated with a set of multiple capabilities, where the first information is determined in accordance with an application specification template that is common to a set of multiple applications, and where the first information is usable by the cloud platform for configuring and managing the set of multiple capabilities via the cloud platform, obtain second information from a first user of the cloud platform, where the second information includes a first request to configure the application for an account of the application that is associated with the first user, and includes a second request to configure a set of capabilities of the application, the set of capabilities selected from among the set of multiple capabilities, redirect the first user to authenticate the first user to obtain access to the application in accordance with an authentication flow for the application, obtain third information in response to redirecting the first user, where the third information includes a credential to authenticate with one or more APIs related to the application, where the credential is associated with one or more permissions that enable the cloud platform to configure and manage the set of capabilities of the application for the account via the provider, and configure the set of capabilities in the application via one or more API calls from the cloud platform to one or more endpoints of the provider, where the one or more API calls are authenticated via the API credential in accordance with the first information.

Some examples of the method, apparatus, and non-transitory computer-readable medium described herein may further include operations, features, means, or instructions for storing the API credential at the cloud platform for performing at least an action in accordance with at least a capability of the set of capabilities.

Some examples of the method, apparatus, and non-transitory computer-readable medium described herein may further include operations, features, means, or instructions for obtaining an indication that triggers the cloud platform to perform the action in accordance with the capability and outputting, in response to the indication, at least an API call via an API that may be associated with the capability, where the API includes an endpoint of the one or more endpoints, and where the API call may be authenticated via the stored API credential.

In some examples of the method, apparatus, and non-transitory computer-readable medium described herein, and the second information further includes an indication of the account and obtaining the API credential that may be associated with the one or more permissions may be based on the account being granted the one or more permissions.

In some examples of the method, apparatus, and non-transitory computer-readable medium described herein, the first information may be indicative of the set of multiple capabilities, a set of multiple endpoints from a set of multiple APIs, a set of multiple credentials, and content associated with the application and the first information may be usable by the first user to identify the application in the cloud platform and to determine the set of multiple capabilities of the application.

In some examples of the method, apparatus, and non-transitory computer-readable medium described herein, each endpoint of the set of multiple endpoints and each credential of the set of multiple credentials may be associated with a respective capability of the set of multiple capabilities.

Some examples of the method, apparatus, and non-transitory computer-readable medium described herein may further include operations, features, means, or instructions for publishing the application via the cloud platform in accordance with the first information, where receiving the first information may be based on the application being published.

In some examples of the method, apparatus, and non-transitory computer-readable medium described herein, the set of multiple capabilities includes a single-sign-on capability, one or more secure session management capabilities, a provisioning capability, an identity governance and access capability, a lifecycle management capability, and a risk signaling capability.

In some examples of the method, apparatus, and non-transitory computer-readable medium described herein, the one or more secure session management capabilities includes a single-log-out capability, a confidence score level based multi-factor authentication management capability, and a confidence score level based permissions management capability.

In some examples of the method, apparatus, and non-transitory computer-readable medium described herein, the first information may be obtained from a developer of the application, an application platform used for developing the application, or an identity platform used by the application.

In some examples of the method, apparatus, and non-transitory computer-readable medium described herein, the first information may be autonomously obtained at the cloud platform.

In some examples of the method, apparatus, and non-transitory computer-readable medium described herein, obtaining the first information may include operations, features, means, or instructions for obtaining a message indicative of the first information.

In some examples of the method, apparatus, and non-transitory computer-readable medium described herein, the message may be obtained via a first API of the cloud platform that may be associated with the provider.

In some examples of the method, apparatus, and non-transitory computer-readable medium described herein, the message includes a form submitted to the cloud platform or an email output to the cloud platform.

### BRIEF DESCRIPTION OF THE DRAWINGS

FIG. 1 illustrates an example of a computing system that supports a dynamic control plane for configuring capabilities across applications via a cloud platform in accordance with aspects of the present disclosure.

FIG. 2 shows an example of a block diagram that supports a dynamic control plane for configuring capabilities across applications via a cloud platform in accordance with aspects of the present disclosure.

FIG. 3 shows an example of a process flow that supports a dynamic control plane for configuring capabilities across applications via a cloud platform in accordance with aspects of the present disclosure.

FIG. 4 shows a block diagram of an apparatus that supports a dynamic control plane for configuring capabilities across applications via a cloud platform in accordance with aspects of the present disclosure.

FIG. 5 shows a block diagram of a capability management service that supports a dynamic control plane for configuring capabilities across applications via a cloud platform in accordance with aspects of the present disclosure.

FIG. 6 shows a diagram of a system including a device that supports a dynamic control plane for configuring capabilities across applications via a cloud platform in accordance with aspects of the present disclosure.

FIG. 7 shows a flowchart illustrating methods that support dynamic control plane for configuring capabilities across applications via a cloud platform in accordance with aspects of the present disclosure.

### DETAILED DESCRIPTION

In some examples, organizations may use cloud computing to increase a performance of the organization. In such examples, however, use of cloud computing (e.g., applications accessed using cloud computing) may lead to security vulnerabilities. As such, some applications may include security features, such as constrained access to the applications or resources included in the applications, or both. For example, an application may request a user (e.g., an employee of an organization) to log into an account within the application using authentication information, such as a combination of a username and a password. The application may use the authentication information to verify an identity of the user. In some examples, however, an organization may use an increased quantity of applications and managing identity and access privileges for several users across several applications may impose a considerable burden on the organizations. For example, for an organization with an increased quantity of employees (e.g., users), managing identity information across multiple applications may impose a considerable burden. As such, an organization may employ a cloud platform (e.g., an identity management system) to manage identity information across multiple applications on behalf of the organization. The cloud platform may therefore provide the organizations with access to multiple applications, while maintaining increased security. In some examples, the organization may wish to use capabilities an application offers, such as capabilities for single sign on (SSO), secure session management, provisioning, identity governance and access, a lifecycle management, and risk signaling, among other types of capabilities. However, different applications may implement one or more capabilities differently (e.g., different applications may work differently). For example, different applications may use different protocol implementations (e.g., openid connect (OIDC), security assertion markup language (SAML), or some proprietary protocol) or may use a same protocol implementation but different parameters (e.g., different uniform resource locator (URLs) or different API routes). Additionally, different applications may use different authentication mechanisms. Employing different mechanisms to integrate different capabilities across multiple applications may necessitate that each capability for each application be implemented individually (e.g., separately), which may be relatively complex and time consuming.

Various aspects of the present disclosure relate to a dynamic control plane for configuring and managing capabilities across applications via a cloud platform and, more specifically, to a single mechanism for configuring and managing applications from a cloud platform over a duration of time. For example, the cloud platform may determine application information for an application that may be associated with various capabilities. The cloud platform may determine the application information in accordance with an application specification template (e.g., a proprietary specification template or a standard specification template) that is common to multiple applications. The cloud platform may determine the application information autonomously (e.g., by itself) or, for example, obtain the information from an application provider (e.g., an independent software vendor (ISV) or another type of application provider) of the application. For example, the cloud platform may have one or more mechanisms for automatically determining the information (e.g., via automated crawlers) or an employee of the cloud platform may collect the information (e.g., manually, or semi-automatically), or some combination thereof. The application information may be usable by the cloud platform for configuring and managing the capabilities of the application. In some examples, the cloud platform may obtain capability request information from a first user of the cloud platform. The capability request information may include a first request for the cloud platform to configure the application for an account of the application that is associated with the first user, and may also include a second request to configure a set of capabilities of the application. The set of capabilities may be selected from among the various capabilities supported by the application. The cloud platform may redirect the first user to authenticate the first user to obtain access to the application (or one or more APIs of the application) on behalf of the first user in accordance with an authentication flow for the application.

The cloud platform may obtain access information in response to redirecting the first user (e.g., in response to the user being successfully authenticated and granting access to the cloud platform). The access information may include a credential (e.g., token) for the cloud platform to authenticate with one or more APIs related to the application. For example, the credential may be associated with one or more permissions that enable the cloud platform to configure and manage the set of capabilities of the application for the account via one or more APIs of the application. Such APIs may be implemented by the application itself (e.g., the application may have system for cross-domain identity management (SCIM) support a developer may have coded for the application) or by an application provider or platform (e.g., the application may support SCIM through a third-party identity platform). The cloud platform may configure the set of capabilities in the application by calling the one or more APIs. The one or more API calls may be authenticated via the credential in accordance with the application information. The application specification template may therefore provide a single mechanism for the cloud platform to list, configure, and manage multiple capabilities across multiple applications. In some examples, using the cloud platform to configure and manage capabilities for applications may lead to increased performance and improved user experience, among other benefits.

Aspects of the disclosure are initially described in the context of a computing system. Aspects of the disclosure are further illustrated in the context of a block diagram and a process flow. Aspects of the disclosure are further illustrated by and described with reference to apparatus diagrams, system diagrams, and flowcharts that relate to a dynamic control plane for configuring capabilities across applications via a cloud platform.

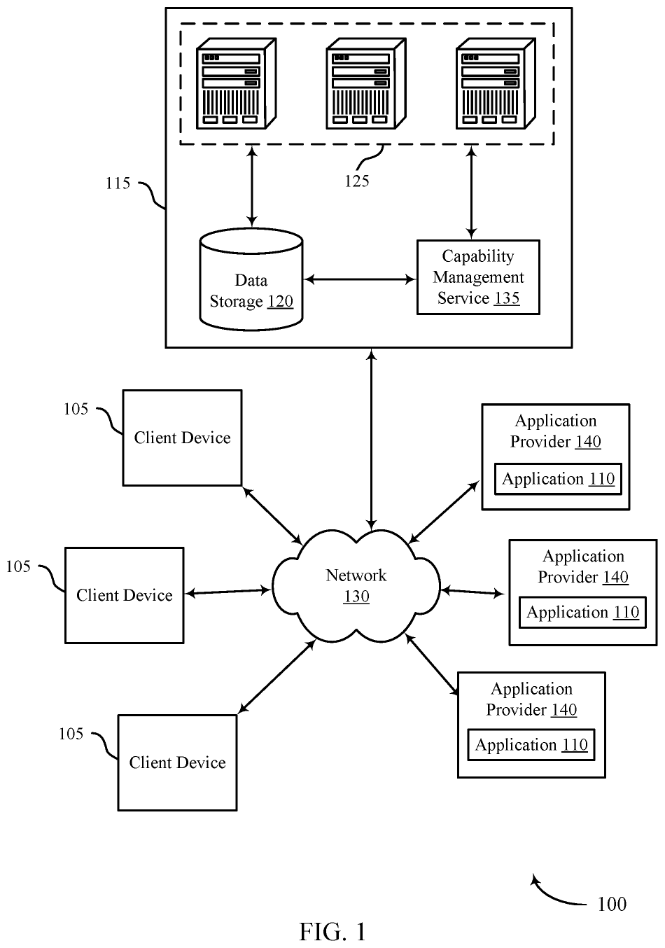

FIG. 1 shows an example of a system 100 that supports a dynamic control plane for configuring capabilities across applications via a cloud platform in accordance with aspects of the present disclosure. The system 100 includes client devices 105, an identity management platform 115 (e.g., a cloud platform), and application providers 140. The identity management platform 115 may include data storage 120, a capabilities management service 135, and one or more servers 125. The identity management platform 115 may communicate with client devices 105 and/or application providers 140 via a network 130 (such as a public or private network). A client device 105 may communicate with an application provider 140 over the network 130.

The network 130 may implement (i.e., utilize) transfer control protocol and internet protocol (TCP/IP), such as the Internet, or may implement other network protocols. The network 130 represents a communication pathway between the identity management platform 115, the client devices 105, and the application providers 140. In one example, the network 130 may use standard wireless and/or wired communications technologies and protocols. In another example, entities on the network 130 may use custom and/or dedicated data communication technologies.

A client device 105 may be an example of a user device, such as a server 125, a smartphone, or a laptop. In other examples, a client device 105 may be a desktop computer, a tablet, or another computing device or system capable of generating, analyzing, transmitting, or receiving communications. In some examples, a client device 105 may be operated by a user that is part of a business, an enterprise, a non-profit, a startup, or any other company type (e.g., organization type). A client device 105 may be configured to execute one or more applications 110. Applications 110 may interact with the client device 105 via email, web, text messages, or any other suitable form of interaction, such as via a business-to-business (B2B) interaction or a business-to-consumer (B2C) interaction. An application 110 may also be referred to as a customer, a client, a website, or some other suitable terminology. In some examples, the application 110 may be an example of a server, a node, a compute cluster, or any other type of computing system, component, or environment. In some examples, the application 110 may be operated by a user or group of users. An application 110 may include a native computing application 110, a cloud-based application 110, a web-based application 110, a network-based application 110, an on-premises application 110, an enterprise application 110, a consumer application 110, or a custom-built internal application 110.

An application provider 140 may be an example of a server, a node, a computer cluster, or any other type of computing system, component, or environment that supports one or multiple applications 110. An application provider 140 may be configured to manage user accounts for multiple applications 110. The application provider 140 may support an API that is usable by external systems (such as the identity management platform 115) to interact with their applications 110. For example, the identity management platform 115 can use a third-party API to log in to a user account of an application 110. An application provider 140 may interact with one or multiple client devices 105 via the network 130. An application provider 140 may use the identity management platform 115 to store, manage, and process data associated with client devices 105. In some cases, an application provider 140 may have an associated security or permission level. For example, users associated with an application provider 140 may have access to particular applications 110, data, and/or database information within the identity management platform 115 based on the associated security or permission level of the application provider 140, and may not have access to others.

The identity management platform 115 may be configured to manage user accounts of various application providers 140. For example, the identity management platform 115 may create user accounts for third-party applications 110, configure the accounts with usernames and passwords, and modify, deactivate, or delete the accounts as needed. In some examples, the identity management platform 115 may configure and manage capabilities for an application 110. For example, the identity management platform 115 may support single sign-on (SSO) by serving as an identity provider (IdP) for one or more service providers (SPs), such as application providers 140. For example, a user can authenticate by logging into the identity management platform 115 via a client device 105. The identity management platform 115 may provide the client device 105 with a single portal from which the user can access various third-party services and applications 110 without additional verification. For example, the user can interact with the portal to specify a particular application 110, and the client device 105 can notify the identity management platform 115 accordingly.

Accordingly, the identity management platform 115 (or a third-party IdP) may access the appropriate authentication information and use it to log into the user's account for the identified service or application 110. For example, in response to the user launching an SSO-integrated application 110 via the client device 105, the identity management platform 115 may automatically provide the relevant authentication information to the corresponding application provider 140. In one example, the identity management platform 115 may provide the relevant authentication information by inserting the information into the appropriate form fields of the application's sign-on screen(s) and executing a “sign-in” command. In another example, the identity management platform 115 may provide SSO services by interacting with an application 110 via an API provided by an application provider 140.

The identity management platform 115 may provide secure user authentication and authorization for various application providers 140 and client devices 105. The identity management platform 115 may simplify the management of user identities and their access to different resources within an organization. When a user joins an organization, their information (e.g., name, email address, username) is entered into the identity management platform 115. As described above, the identity management platform 115 may support SSO, enabling users to access multiple applications 110 with a single set of credentials. Users can log in to the identity management platform 115 (e.g., via a client device 105) with their username and password, and access all their authorized applications 110 without having to enter their credentials again. The identity management platform 115 may also provide various authentication services, including username and password, multi-factor authentication (MFA), and social login. MFA adds an extra layer of security by prompting users to provide additional verification, such as a code from a mobile application 110 or a fingerprint scan. The identity management platform 115 may act as a central user directory, storing user profiles and data in a data storage 120. The identity management platform 115 may be capable of integrating with existing directories using Active Directory (AD) or Lightweight Directory Access Protocol (LDAP), ensuring a centralized source of user information.

The identity management platform 115 may be configured to or otherwise capable of integrating with a wide range of applications 110, such as native computing applications 110, cloud-based applications 110, and on-premises applications 110. The identity management platform 115 may support Security Assertion Markup Language (SAML) and OpenID Connect (OIDC), enabling secure communication between the identity management platform 115, client devices 105, and application providers 140. The identity management platform 115 may enable administrators to define policies and rules to control user access to resources. Administrators can set permissions based on factors like user roles, groups, and attributes. The identity management platform 115 can automate user lifecycle management tasks such as provisioning, deprovisioning, and user updates. When a user joins or leaves an organization, their access to applications 110 and resources can be automatically granted or revoked, reducing administrative overhead. Additionally, or alternatively, the identity management platform 115 may provide security features to protect user identities and data. For example, the identity management platform 115 may support encryption, threat detection, and monitoring capabilities to ensure the integrity and confidentiality of user information. The identity management platform 115 may also help organizations comply with various regulatory constraints.

In some examples, the identity management platform 115 may be implemented as a multi-tenant cloud system. For instance, the identity management platform 115 may serve multiple tenants (i.e., organizations or services) with a single instance of software. However, other types of systems may be implemented, including—but not limited to—client-server systems, mobile device systems, and mobile network systems. In some implementations, the identity management platform 115 may have one or more clouds, such as one or more identity clouds, among other types of clouds for application providers 140. The identity management platform 115 may receive data associated with client devices 105 from application providers 140 over the network 130, and may store/analyze the data. In some cases, the identity management platform 115 may receive data directly from a client device 105 and/or an application provider 140. The identity management platform 115 may include one or more servers 125. In some cases, the servers 125 may be integrated with or otherwise connected to the data storage 120.

The servers 125 may be used for data storage 120, management, and/or processing. The data storage 120 may communicate with other components of the identity management platform 115 via a network connection. The data storage 120 may leverage redundancy for security purposes. In some cases, data stored at the data storage 120 may be backed up by copies of the data at another data storage 120. In some cases, data processing may occur at any of the components of the identity management platform 115, or at a combination of these components. In some cases, servers 125 may perform the data processing.

The identity management platform 115 may be an example of a multi-tenant system. For example, the identity management platform 115 may store data and provide services, solutions, or any other functionality for multiple tenants concurrently. A tenant may refer to a group of users (e.g., an organization) who share access, privileges, or both. The identity management platform 115 may effectively separate data and processes for a first tenant from data and processes for other tenants using a system architecture, logic, or both that support secure multi-tenancy. In some examples, the identity management platform 115 may include or be an example of a multi-tenant database system that stores data for different tenants (such as application providers 140) in a single database or a single set of databases. To support multi-tenant security, the multi-tenant database system may prohibit (e.g., restrict) a first tenant from accessing, viewing, or interacting in any way with data associated with a different tenant. As such, data of the first tenant may be isolated (e.g., logically isolated) from data of a second tenant, and the tenant data for the first tenant may be inaccessible to the second tenant. The identity management platform 115 may additionally use encryption techniques to further protect tenant-specific data from unauthorized access (e.g., by another tenant).

The identity management platform 115 may support any configuration for providing multi-tenant functionality. For example, the identity management platform 115 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The identity management platform 115 may support scaling of tenants within the multi-tenant system, for example, using scale triggers, automatic scaling procedures, scaling requests, or any combination thereof. In some cases, the identity management platform 115 may implement one or more scaling rules to promote sharing of resources across tenants. For example, a tenant may have a threshold quantity of processing resources, memory resources, or both.

Some application providers 140 may publish applications 110 to the identity management platform 115. For example, the identity management platform 115 may obtain application information for an application 110 that may be associated with various capabilities. The identity management platform 115 may obtain the application information in accordance with an application specification template that is common to multiple applications 110. The identity management platform 115 may obtain the application information itself (e.g., autonomously) or, for example, from an application provider 140 of the application 110. The application information may be usable by the identity management platform 115 for configuring and managing the capabilities of the application 110 for particular tenants (e.g., organizations) of the identity management platform 115. In some examples, the identity management platform 115 may obtain capability request information from a first user of the identity management platform 115. The capability request information may include a first request for the identity management platform 115 to configure the application for the particular tenants of the identity management platform 115, and may also include a second request to configure a set of capabilities of the application 110. The set of capabilities may be selected from among the various capabilities supported by the application 110. The cloud platform may redirect the first user to authenticate the first user to obtain access to the application 110 (or APIs of the application) on behalf of the first user in accordance with an authentication flow for the application 110. The identity management platform 115 may obtain access information in response to redirecting the first user (e.g., in response to the user being successfully authenticated and granting access to the identity management platform 115). The access information may include one or more credentials (e.g., one or more tokens) for the identity management platform 115 to authenticate with one or more APIs related to the application 110. Each credential may be associated with one or more permissions that enable the identity management platform 115 to configure and manage the set of capabilities of the application for the account via the respective API of the application 110. In some examples, the API may be hosted by an application provider of the application (e.g., an ISV, a third-party platform). The identity management platform 115 may configure the set of capabilities in the application 110 via one or more API calls from the identity management platform 115 to one or more endpoints of the application provider 140. The one or more API calls are authenticated via the credential in accordance with the application information.

It should be appreciated by a person skilled in the art that one or more aspects of the disclosure may be implemented to solve additional or alternative problems (other than those described above). Furthermore, aspects of the disclosure may provide technical improvements relative to “conventional” systems or processes described herein. However, the description and appended drawings only include example technical improvements that result from implementing aspects of the disclosure and, accordingly, do not represent all of the technical improvements provided within the scope of the claims.

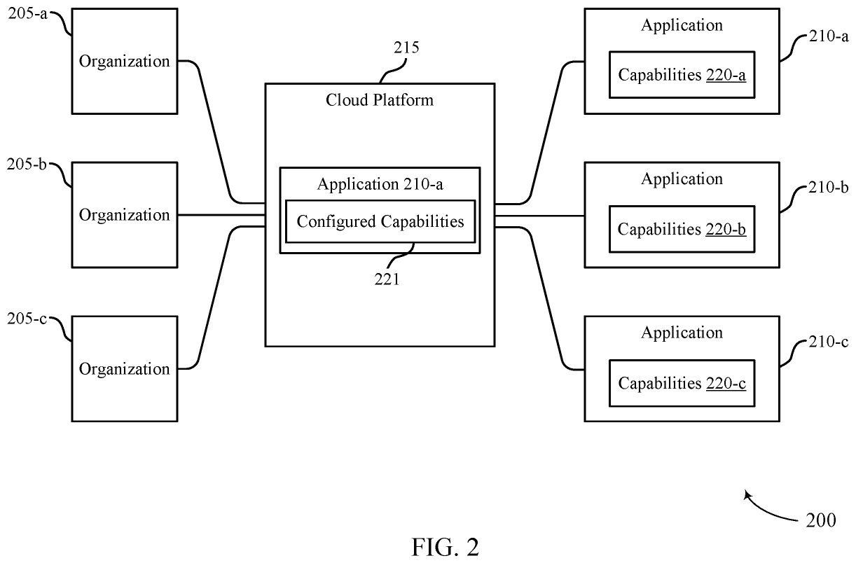

FIG. 2 shows an example of a block diagram 200 that supports a dynamic control plane for configuring capabilities across applications via a cloud platform in accordance with aspects of the present disclosure. In some examples, the block diagram 200 may implement or be implemented by aspects of the system 100. For example, the block diagram 200 may be implemented at cloud platforms 215, which may be an example of an identity management platform 115 (also referred to herein as an identity management system) illustrated by and described with reference to FIG. 1.

In some examples, organizations 205 (e.g., an organization 205-a, an organization 205-b, an organization 205-c) may use cloud computing, such as cloud applications (e.g., an application 210-a, an application 210-b, an application 210-c), to increase a performance of the organization 205 (e.g., companies, enterprises). In such examples, however, use of cloud applications may lead to security vulnerabilities. As such, some cloud applications may include security features (e.g., capabilities). For example, a cloud application may request a user (e.g., an employee of an organization) to log into an account within the cloud application using authentication information, such as a combination of a username and a password. The cloud application may use the authentication information to verify an identity of the user. In some examples, however, an organization may use an increased quantity of cloud applications and managing identity and access privileges for several users across several applications may impose a considerable burden on the organizations. That is, multiple cloud applications may include an identity management feature (e.g., an IAM feature) that users (e.g., each employee of the organization) of the cloud applications may comply with to use the cloud applications. For organizations with an increased quantity of employees (e.g., users), managing authentication information across the multiple cloud applications may impose a considerable burden.

In some examples, the organizations 205 may employ the cloud platform 215 to manage authentication information across the multiple cloud applications (e.g., application 210-a, application 210-b, application 210-c). For example, the organizations 205 may use a quantity of technology vendors (e.g., ISVs) for internet, collaboration (e.g., within the organization and external to the organization), email, and billing, among other possible examples. Additionally, as the size of the organizations 205 increases, the organizations 205 may use more technology and, accordingly, an increased quantity of technology vendors. For example, the organizations 205 may utilize more resources, such as software applications (e.g., cloud applications), and may have multiple types of users of those resources, such as employees, contractors, and customers, among other examples. In some examples, the organizations 205 may implement one or more platforms (e.g., software platforms) for collaboration or for infrastructure, however, features provided by such platforms may fail to include some services to be implemented within the organization. That is, the likelihood of a single platform providing each service (e.g., all services, all applications) to be implemented within the organizations 205 may be relatively low and may constrain resources used by the organizations 205. For example, to reduce a quantity of platforms used by an organization, the organization may determine to constrain resources used by the organization to resources (or features) provided by a platform used by the organization for collaboration or for infrastructure (e.g., the platforms may become silos).

In some examples, however, the organizations 205 may utilize the cloud platform 215 to increase technology adoption within the organizations 205. For example, the cloud platform 215 may provide a workforce (e.g., a boundaryless workforce) with a zero-trust approach, which may lead to increased business performance. In some examples, a boundaryless workforce may refer to a workforce that includes employees, seasonal workers, contractors, and business partners that may be associated with an organization (e.g., and may be using multiple devices across multiple locations) and may use multiple resources (e.g., applications, infrastructure, APIs, cloud and on-premises servers) associated with the organization. That is, an organization (e.g., one or more of the organizations 205) may be associated with multiple types of users (e.g., employees, seasonal workers, contractors, and business partners) that may access multiple types of resources managed by (or utilized by) the organization. In such an example (e.g., with no clear boundary around resource access associated with the organization), the organization (e.g., a company) may extend a zero-trust posture of the organization to each user (e.g., the contractors, business partners, and employees, such as front office workers) to increase a performance of the organization. That is, a trust boundary associated with the organization may include each entity (e.g., any person or other organization) associated with the organization.

For example, a device of an employee of the organization (e.g., a computer of a support representative at a call center of the organization) may be breached. In such an example, while a technical impact of the breach may be relatively small (e.g., the breach may occur at a single computer), the breach may negatively impact a trust boundary within the workforce of the organization and other organizations (e.g., third parties) associated with the organization. For example, such a breach may lead to security vulnerabilities for the organization and third parties associated with the organization. Accordingly, the organization may implement the cloud platform 215, such that a technology environment for third parties and the workforce of the organization may have increased security protections (e.g., from breaches). For example, the organizations 205 may implement the cloud platform 215 to reduce identity challenges and increase security for the organizations 205.

In some examples, the cloud platform 215 may enhance onboarding for workforces (e.g., boundaryless workforces) of the organizations 205. For example, identity governance features supported at the cloud platform 215 may enable a workforce of an organization (e.g., one or more of the organizations 205) to obtain suitable entitlements to tools the workforce may use for work (e.g., tasks, jobs). In some examples, entitlements may change throughout a life cycle of the workforce within the organization. For example, a user associated with the organization (e.g., a contractor) may complete a project and, accordingly, may refrain from utilizing access to an application associated with the organization that may be granted to the employee for the project. In such an example, an access certification feature supported at the cloud platform 215 may be used to inform another user (e.g., an employee included in an information technology (IT) team) associated with the organization of a contract expiration or extension associated with the contractor. That is, the identity governance and access management features (e.g., IGA and IAM capabilities) supported at the cloud platform 215 may enable the cloud platform 215 to increase security for multiple users across multiple stages of a respective lifecycle of the multiple users within the organization. For example, the cloud platform 215 may include features for automating access policy enforcement with access certification campaigns and automated reports. In some examples, the access requests may be used in accordance with one or more applications utilized by the organization. For example, the access requests may be transmitted or received (e.g., between users associated with the organization or between the cloud platform 215 and users associated with the organization) with a chat-based (e.g., messaging-based) application. Additionally, or alternatively, the access request may include a capability (e.g., using workflows) to orchestrate access governance (e.g., with relatively low or no code provided by the organization), such that the organization may (e.g., automatically) identify inactive users. In some examples, the cloud platform 215 may support multiple types of resources including business applications and infrastructure. Additionally, or alternatively, each resource may include a scale (e.g., a sliding scale) of entitlements, which may range from cloud application access to relatively highly privileged access (e.g., that may be closely guarded and timebound). As described herein, entitlements may refer to resources (e.g., software applications or resources within software applications) that a user may be granted access to use (e.g., may own).

In some examples, the cloud platform 215 (e.g., an identity cloud, a workforce identity cloud) may enable increased performance for users (e.g., employees associated with respective IT teams or security teams within the organizations 205) across multiple stages of an identity lifecycle. For example, the cloud platform 215 may enable the organizations 205 to complete projects relatively quickly, remediate security threats (e.g., in real time), and provide information to stakeholders associated with the organizations 205.

In some examples, the cloud platform 215 may correspond to technology the organizations 205 may use to connect to multiple (e.g., all) resources. For example, the cloud platform 215 may facilitate access to the applications 210 for the organizations 205, such that respective users (e.g., employees) associated with the organizations 205 may obtain suitable technologies for a suitable quantity of time (e.g., in a zero-trust environment). For example, access to a resource may lead to increased security risks for a workforce of an organization (e.g., one or more of the organizations 205). In such examples, the organization may use the cloud platform 215 to enable multiple users (e.g., employees) associated with the organization access to multiple types of resources (e.g., techniques, such as cloud applications) to be used to complete work (e.g., jobs, tasks). For example, the cloud platform 215 may correspond to an identity provider (e.g., a single identity provider, a single control plane, a single directory) for applications, systems, and tools, among other examples of resources, utilized within the organization. Additionally, or alternatively, the cloud platform 215 may provide automation for identity compliance and business processes, including onboarding applications for users, onboarding users (e.g., employees), compliance reviews for users, role changes of users within the organization, and departures of users from the organization.

In some examples, the cloud platform 215 may reduce the likelihood of malicious cyber-attacks, such as credential theft or phishing attacks, succeeding. As described herein, a phishing attack may refer to a type of malicious cyber-attack in which an attacker may transmit a message (e.g., an email) to a user in an attempt to obtain information associated with the user (or other users) or to deploy malicious software on an infrastructure (e.g., computer, server) associated with the user. For example, some attackers may use websites to carry out phishing attacks to obtain credentials associated with an organization (e.g., one or more of the organizations 205). In such an example, as the quantity of websites used for phishing attacks increases, a susceptibility of the organization to the phishing attacks (e.g., a likelihood of the organization being a victim of a phishing attack) may also increase. Accordingly, to reduce the likelihood of malicious attacks succeeding, the cloud platform 215 may provide a framework for passwordless authentication. For example, the cloud platform 215 may provide a workforce of the organization with passwordless authentication to access resources for work. In some examples, the workforce (e.g., employees, contractors, and suppliers) of the organization may include hybrid and remote roles, which may lead to an increased risk for the organization. In such examples, however, the cloud platform 215 may provide passwordless authentication across multiple types of resources (e.g., the applications 210, actions, single sign-on (SSO) interactions, social connections, log streams), multiple types of devices (e.g., smartphones, laptops, desktops, wearable devices), and multiple types of operating systems. For example, the passwordless authentication features provided using the cloud platform 215 may reduce phishing attacks that may target multiple types of users and multiple types of resources associated with the organizations 205. That is, the cloud platform 215 may provide one or more phish-proof identity solutions across user types and devices associated with the organizations 205. As described herein, phish-proof may refer to a capability to reduce (e.g., minimize) successful phishing attacks.

In some examples, the cloud platform 215 may provide one or more enhancements for controls of other authenticators, such as factors associated with web authentication APIs and fast identity online (FIDO) authentication credentials (e.g., passkeys). For example, the cloud platform 215 may provide customizable authentication, such that an organization (e.g., one or more of the organizations 205) may select authentication factors that align with a security posture of the organization. As described herein, a security posture may refer to a security status of a network (e.g., people, hardware, software, policies) associated with an organization. Additionally, or alternatively, the passwordless features provided by the cloud platform 215 may extend phish-proof identity solutions beyond some users (e.g., employees) of the organization to extend an ecosystem of the organization. For example, the phish-proof identity solutions may include employees, contractors, and customers, among other examples of users that may be associated with the organization. In such an example, by using the cloud platform 215 as an identity provider, the organization may allocate more resources (e.g., energy, time, finances) to customers of the organization and less resources to managing authentication credentials.

In some examples (e.g., in addition to enabling phish-proof identity solutions for multiple types of users associated with the organizations 205), the cloud platform 215 may provide access that may be unconstrained to a single point in time and unconstrained to a single resource. That is, the cloud platform 215 may provide access across multiple resources for an extended duration. For example, the cloud platform 215 may support the principle of least privilege (POLP) access in which an organization (e.g., one or more of the organizations 205) may customize authentication for users associated with the organization, such that the users may be granted permission to read, write, or execute resources to perform work. In some examples, the cloud platform 215 may support least privilege access and governance across a lifecycle associated with a user (e.g., across multiple roles the user may fill within the organization) and across multiple resources. In some examples, a component (e.g., each component) of IAM, IGA, and PAM supported by the cloud platform 215 may provide increased control to the organization (e.g., teams within the organization) with reduced complexity, reduced resource overhead, and increased security. The identity governance (e.g., IGA) and privileged access (e.g., PAM) features supported by the cloud platform 215 may enable the organizations 205 to identify users (e.g., determine which users) may be provided access to one or more resources (e.g., which resources) with reduced (e.g., minimal) complexity.

For example, the identity governance features provided by the cloud platform 215 may enable customers of an organization (e.g., one or more of the organizations 205) to automate multiple types of actions across access management and governance systems associated with the organization, while increasing productivity for some users (e.g., IT teams) associated with the organization (e.g., and without reducing workforce agility). Additionally, or alternatively, the privileged access features provided by the cloud platform 215 may provide enhanced PAM, in which privileged governance, secrets management, and compliance audit capabilities that may be used by the organization (e.g., by IT and security teams within the organization) for PAM may be combined within the cloud platform 215 (e.g., a same workforce identity solution). Accordingly, the cloud platform 215 may enable privileged users benefits and phish-proof passwordless access. For example, the cloud platform 215 may enable the organizations 205 to operate without single-use (e.g., one-off) passwords, identity siloes, and relatively bloated software.

For example, the organization 205-a may include a workforce of multiple users (e.g., tens of thousands of users, such as tens of thoughts of employees, contractors, and suppliers) across multiple locations (e.g., hundreds of thousands of locations) and multiple server instances. In such an example, the cloud platform 215 may provide a unified solution in which a first user (e.g., an engineer) in a first location may request access to a cloud server associated with the cloud platform 215. In some examples, the first user may request access to the cloud server from another user (e.g., a manager) in a second location. In such an example, using the cloud platform 215, the first user may be granted access to the cloud server relatively quickly (e.g., instantly), for example, without using a static credential or transmitting the request to the second user (e.g., via a ticket to be filled). Additionally, or alternatively, the cloud platform 215 may restrict the access granted to the first user (e.g., automatically) in response to the cloud platform 215 detecting a relatively high-risk login attempt (e.g., with an audit trail for multiple steps of the authentication process). That is, the cloud platform 215 may provide the organizations 205 with phish-proof access to multiple resources, centralized identity management for the multiple resource, and enable automated compliance capabilities across the lifecycle of respective users associated with the organizations 205. As described herein, centralized identity management may refer to the collection and storage of user identity data, such that users may access multiple resources (e.g., applications, websites, or other systems) with the same set of credentials.

In some examples, it may be desirable for the applications 210 to support access management, extensibility, login security, and user management, among other possible features. For example, users of the applications 210 (e.g., users associated with the organizations 205) may wish to login to the applications 210 with multiple types of passwordless or social login methods. Additionally, or alternatively, an ISV (e.g., a developer) of an application (e.g., one or more of the applications 210) may wish to determine whether a user of the application may correspond to a bot or a legitimate user. In some examples, developers and users of the organizations 205 may wish for features associated with preventing the use of breached credentials (e.g., credentials breached from the applications 210). That is, users may wish to use and developers may wish to build applications with enterprise-ready identity features. As described herein, enterprise-ready identity features may refer to identity features that may be suitable for organizations with constraints that may be distinct from consumer or relatively small business segments. In some examples, however, integrating enterprise-ready identity features into an application (e.g., one or more of the applications 210) may be relatively complex. Accordingly, some developers (e.g., ISVs) may determine to integrate (e.g., deploy) applications with the cloud platform 215, for example, directly or via another cloud platform.

In some examples, the cloud platform 215 may provide a mechanism (e.g., a v1 mechanism) for partners (e.g., other organizations that may be associated with one or more of the organizations 205) to integrate applications with the cloud platform 215. Such applications may include various features (e.g., capabilities) which may be carried out by (e.g., configured, managed) the cloud platform 215. Privileged access management features supported by the cloud platform 215 may include privileged access as a service, which may enable customers (e.g., the organizations 205, developers of the applications 210) to achieve compliance and business continuity by securing human, machine, and application access to resources. For example, the customers may be capable of satisfying IAM, IGA, and PAM constraints (e.g., criteria) using the cloud platform 215. In some examples, using the cloud platform 215 for PAM may enable the organizations 205 to satisfy evolving compliance and security constraints with a cloud-native PAM feature that may be integrated with respective infrastructures of the organizations 205. For example, using the cloud platform 215, the organizations 205 may implement a zero-trust approach to security. In some examples, the PAM capability supported at the cloud platform 215 may provide credential vaulting and rotation for local user accounts and human-managed shared secrets, and may provide just-in-time (JIT) access request and approval workflows for human, machine, and application users alike, which may reduce unnecessary standing permissions an attack surface associated with the organizations 205 (e.g., using a least privilege model, a POLP model). Additionally, or alternatively, the PAM capability supported at the cloud platform 215 may provide privileged access reports and session management capabilities, which may provide an audit trail to detect and prevent unwanted behavior, and to aid in verifying (e.g., proving) compliance. In some examples, the cloud platform 215 may provide passwordless access management using ephemeral certificate-based authorization for multiple types of infrastructures (e.g., multiple types of platforms, networks, or systems). In some examples, a least privilege model may correspond to a model for reducing (e.g., minimizing) a quantity of access to privileged resources at a given time, and reduced elevation of privileges. For example, a relatively high percent (e.g., about 80%) of breaches may target servers. Accordingly, the cloud platform 215 may contain access to a server by a server administrator. For example, the cloud platform 215 may refrain from granting some privileges to the server administrator.

In some examples, the PAM capabilities (e.g., features) supported at the cloud platform 215 may include vaulting and rotation of privileged account credentials, secrets management, sing-sign-on and zero-trust access to infrastructures (e.g., servers, k8s, and managed resources including databases and applications), PAM compliance reporting, PAM access requests and approvals, PAM zero standing privileges and step-up of multi-factor authentication, PAM session recording, PAM session management, cloud infrastructure entitlements management, PAM audits and even logging, and PAM access certifications, among other examples of PAM capabilities.

In some examples, the PAM capabilities (e.g., features) supported at the cloud platform 215 may include use of an ephemeral credentials-based server access service that may be extended to include a relatively wide range of infrastructure, such as a cloud-native k8 infrastructure and one or more databases. Additionally, or alternatively, the PAM capabilities may include using a cloud-native vault for shared account password management. In some examples, the PAM capabilities of the cloud platform 215 may support both a developer requesting access to a cloud-native k8 infrastructure cluster and an administrator requesting root access to perform maintenance changes.

In some examples, the PAM capabilities may be integrated with the identity governance capabilities to support the least privilege model. For example, using the cloud platform 215, the organizations 205 may implement (e.g., and integrate) multiple tools, including an IAM tool for access, an IGA tool for governance, a PAM tool for privileged resources, and a cloud infrastructure entitlement management (CIEM) tool for cloud entitlements, which may reduce a burden associated with manually integrating such tools. That is, the multiple tools supported at the cloud platform 215 may enhance security, connectivity, and automation for workforce identity and access management within the organizations 205.

In some examples, everything as a service (XaaS) capabilities supported at the cloud platform 215 may include human resources as a Source functionality to automate IT processes associated with a user (e.g., an individual) joining, moving within, or leaving the organizations 205. For example, some human resources as a source systems may constrain organizations to use a human resources system with an existing integration network or an on-premises deployment. In some other examples, the XaaS capabilities supported at the cloud platform 215 may provide human resources as a source capability (or multiple source capabilities) to multiple sources of truth (e.g., any source of truth). For example, the cloud platform 215 may provide an API, which the organizations 205 may use to send data from a source (e.g., to the cloud platform 215) and use a human resources system as a source capability included in the cloud platform 215, such as user confirmation, user matching and linking, profile mappings, and import monitoring, among other examples. In some examples, using the cloud platform 215 for human resource services may enable users to write custom connectors or leverage workflows to identities from multiple sources.

In some examples, features for phishing-resistance supported at the cloud platform 215 may determine whether authentication requests may be from an authentic (e.g., correct, suitable) server, thereby providing phishing-resistance for multiple (e.g., all) managed devices and platforms used on devices managed by the organizations 205 and devices unmanaged by the organizations 205 (e.g., using channel binding). For example, an attacker transmits a message (e.g., an email) to a user associated with the organization 205-a and the message may include a malicious link to an unauthentic server (e.g., a spoofed site). In such an example, the user may use the cloud platform 215 to attempt to log onto the unauthentic server in response to receiving the message. In response, the software platform may stamp a key associated with the unauthentic server, which the attacker may obtain (e.g., intercept). In some examples, the attacker may attempt to use the key provided by the cloud platform 215 from the unauthentic server on a corresponding authentic server. In such examples, the key may fail. That is, in response to detecting that the server associated with the link is unauthentic, the cloud platform 215 may perform one or more actions to ensure that the key obtained by the attacker may not be used to access resources associated with the cloud platform 215 (e.g., protected websites and applications).

In some examples, multi-factor authentication (MFA) features (e.g., capabilities) supported at the cloud platform 215 may include biometric web login. For example, the cloud platform 215 may support expanded options for use of biometrics (e.g., face identification, touch identification, fingerprint identification) for an improved passwordless experience for users. Additionally, or alternatively, the MFA features supported at the cloud platform 215 may include enhanced security checks for unmanaged devices, which may support capabilities to perform security posture checks for unmanaged devices and define suitable access policies to enforce the security posture. For example, such in accordance with MFA features the cloud platform 215 may perform one or more verification processes if an application is installed on a device (e.g., a phone, a tablet) of a user associated with the organizations 205, such that the organizations 205 may obtain information associated with a security posture of the device. In some examples, the verification processes may include detecting one or more signals, such as signals that may indicate whether the device may have been jailbroken (e.g., modified to remove restrictions imposed by the manufacturer or operator to allow the installation of unauthorized software), an OS version of the device, whether the device may have a code (e.g., a PIN code) to unlock a lock-screen of the device, and whether disk encryption may be enabled at the device. The cloud platform 215 may support such verification processes for multiple types of devices and multiple types of operating systems, such as to enable respective administrators of the organizations 205 to build customizable security policies, and understand whether devices used for activities associated with the organization may have updated operating systems, and use PIN codes, among other examples.

In some examples, workflows supported at the cloud platform 215 may include workflow solution packs, which may aid the organizations 205 (e.g., customers) with identity-based automation by using a bundled collection of customizable (e.g., and prebuilt) templates that are to be used for performing tasks. For example, the workflow solution packs may include templates for capturing contract signatures, account provisioning, device activation, and transmitting notifications across multiple devices associated with the organizations 205. In some examples, the workflow solution packs may include security templates, which may enable automation across security operation center processes used within the organizations 205. For example, the security template may enable the cloud platform 215 to detect and respond to security incidents by identifying changes in user behavior, such as risks that may create a risk to the organization 205. Additionally, or alternatively, the security template may enable the organizations 205 to continuously monitor and improve a respective security posture associated with the organizations 205. That is, the security templates may provide support for respective security operations teams associated with the organizations 205, by providing customizable (e.g., and pre-bult) workflows for security awareness, identity automation and response, incident investigation and response, threat intelligence, and user behavior analytics. In some examples, the security templates may provide automations for security policy enforcement at the identity layer, detecting and responding to suspicious user or entity activity by identifying changes in user behavior, such as changes that may create a risk to the organization, and monitoring (e.g., continuous monitoring) of a security posture associated with the organization.

In some examples, one or more connector builders supported at the cloud platform 215 may provide for building workflows connectors within a no-code flow designer (e.g., supported at the cloud platform 215). For example, using a connector builder, ISVs (e.g., developers) may build connectors for the organizations 205 (e.g., customers), and respective administrators of the organizations 205 may build connectors to connect custom tools (e.g., to the applications 210). That is, the connector builder may provide for no-code development of workflows connectors in which organizations, ISVs, and developers, among other examples may use workflows to build a connector (e.g., using a drag and drop interface), which may lead to on-demand productized connectors to third party or internal systems with an API available on the public internet. In some examples, the connectors and templates may be used to automate prevention and response use cases to support enhanced security.

In some examples, use of workflows may reduce the time duration used to deploy applications and enable relatively smooth and secure provisioning for privileged accounts, such as system administrators. For example, some users may rely on standard accounts for computer login, email, and other user tasks, which may necessitate logging into separate privileged accounts to perform higher-level administrative tasks. In some other examples, the no-code workflows platform service supported at the cloud platform 215 may enable the users to perform such tasks using a SSO (e.g., via the cloud platform 215).

In some examples, verification features supported at the cloud platform 215 may include features capable of attesting and verifying an identity of a user in an end-to-end encrypted video conference call (e.g., without involving a backend infrastructure used for communications between the cloud platform 215 and the application in which the video conference call is being performed). In some examples, using such verification features may enable the organizations 205 to create a password-optional or passwordless sign-in experience for end users, which may reduce a quantity of time associated with registration and increase security associated with the sign-in experience as users may obtain relatively stronger authenticators such as possession-based authenticators or biometrics. In some examples, using such authenticators may reduce password management for end users (e.g., including remembering or maintaining passwords through one or more other tools).

In some examples of passwordless onboarding using the cloud platform 215, a first user (e.g., an IT administrator associated with the organization 205-a) may set policies for users to ensure end-to-end passwordless and phishing-resistant access. In such examples, the organization 205-a may use the software platform to enroll and onboard a second user (e.g., an employee of the organization 205-a) with zero passwords. Additionally, or alternatively, a third user (e.g., a contractor of the organization 205-a) may use the cloud platform 215 to obtain secure access to resources associated with the organization 205-a. In some examples, the third user may login and begin downloading files (e.g., media files) from a resource associated with the application 210-a. In such an example, the application 210 may detect the activity and use workflows (e.g., setup by the organization 205-a using the cloud platform 215) to notify the cloud platform 215. In such an example, the cloud platform 215 may suspend access of the third user (e.g., suspend the third user's session) to the application and one or more other applications the third user may have access to. Additionally, or alternatively, the cloud platform 215 may transmit an indication of the event to one or more users (e.g., a security operations team) associated with the organization 205-a or one or more other organizations.

For example, the cloud platform 215 may support super federation, in which the cloud platform 215 may provide one-click configuration (e.g., one-click federation). For example, some techniques for implementing (e.g., onboarding) applications and enabling capabilities for the applications may be relatively challenging and error prone. For instance, some configuration screens in the applications may be relatively complex and use SAML, assertion customer service uniform resource locators (ACS URLs), signing certificates, name identifiers, and claim mapping, among other examples. In such an example, administrators onboarding such applications may use an increased quantity of time copying and pasting information from multiple (e.g., different) documents to satisfy constraints of the application (e.g., signing certificates, name identifiers) in an attempt to configure SSO. Additionally, or alternatively, such information may be updated in response to an integration change, which may introduce errors or latency.

In some other examples, using the one-click configuration supported at cloud platform 215, ISVs may automate the configuration of an identity provider using reduced (e.g., minimal) user input. For example, using the cloud platform 215, the ISVs may begin a registration process based on an email address associated with the user (e.g., using a tool provided by the cloud platform 215 for attaching information to an email address or other online resources) or by requesting the user to enter a FastFed Discovery Endpoint. In such an example, in response to beginning the registration process an IT administrator (or other user associated with the organization) may be redirected to the associated identity provider (e.g., the cloud platform 215), which the IT administrator may use to confirm the registration process. In some examples, after completing the registration process, resources may be created (e.g., the application may become integrated into the cloud platform 215 and the cloud platform 215 may become registered as the identity provider). In such an example, a connection (e.g., a communication channel) may be established for use in signing key rotation and other (e.g., future) scenarios. In some examples, the cloud platform 215 may support safer shadow IT. For example, configuring SSO may, in some examples, be performed by the IT administrator, which may lead to one or more issues, for example if an application has not been onboarded. In some examples, the IT administrator may use a free-tier or on a trial account to configure SSO, which may lead to one or more security risks. Additionally, or alternatively, the company may lack visibility of applications used by the employees.

In some examples, the cloud platform 215 may support a marketplace in which ISVs that use the cloud platform 215 may offer advanced capabilities (e.g., as part of applications) to users (e.g., in the marketplace). For example, a user may use an application (e.g., a SaaS application) from the marketplace. In such an example, IT administrators may be capable of installing applications from within the marketplace. In some examples, the installation may establish a connection (e.g., a channel) to the application. For example, the connection may occur between an account within the application and the directory associated with the organization. In some examples, the cloud platform 215 may provide subscription and license management features which may integrate with one or more IGA capabilities, including future IGA capabilities. In some examples, in response to installing an application the IT administrator may be provided an option to connect to the cloud platform 215 (e.g., may be provided with the one-click configuration).

In some examples, the cloud platform 215 may support SAML and OIDC as well as standardize protocols for identity providers. Additionally, or alternatively, the cloud platform 215 may reduce friction associated with onboarding (e.g., customer acquisition), reduce password management or recover flows for the organizations 205, and may enable the organizations 205 to delegate account management and multi-factor authentication to the cloud platform 215. In some examples, the cloud platform 215 may enable users (e.g., end-users) to self-serve SSO applications, reduce thread of account takeover, reduce credential reuse or leaks, enable enforcement of multi-factor authentication for non-IT managed applications, reduce security events, and provide visibility of shadow IT by providing information associated with applications used by employees. In some examples, the cloud platform 215 may reduce friction for enterprise adoption of SaaS applications (e.g., increased licenses), reduce support costs for SSO, and increase security (e.g., reduce liability) for SaaS applications (e.g., no passwords). Additionally, or alternatively, the cloud platform 215 may support relatively seamless (e.g., zero downtime) upgrades for applications and enable automated workflows for scalability. In some examples, the cloud platform 215 may support a mapping for enterprise ready features, differentiation from competitors, and reduce a barrier associated with adoption of applications by relatively large organizations. Additionally, or alternatively, the cloud platform 215 may support governance and security controls for self-service adoption, scalability of security controls and enforcement, and reduce manual steps in security management. In some examples, the software platform may support increased adoption or engagement and “stickiness” by enabling employees to collaborate with teams and companies and enable ISVs (e.g., providers) to obtain information from organizations using the applications without identity provider pushes. Additionally, or alternatively, the cloud platform 215 may support fine-grained delegation of an enterprise directory to applications (e.g., which may be auditable). In some examples, the cloud platform 215 may promote funnel conversion to paying customers and integrating billing and procurement.

In some examples, the organizations 205 may integrate (e.g., use, configure) one or more of the applications 210 (e.g., SaaS applications) via the cloud platform 215. For example, the organization 205-a (e.g., a tenant) may integrate the application 210-a via the cloud platform 215. The cloud platform 215 may support a dynamic control plane that the cloud platform 215 may use to set up (e.g., configure) and manage capabilities of the applications 210 for the organizations 205. As described herein, the dynamic control plane may refer to a bidirectional communication channel between the cloud platform 215 and APIs of the configured application 210-a (e.g., the application APIs). Accordingly, the dynamic control plane may include an API of the cloud platform 215 that is associated with an integration network of the cloud platform 215 (e.g., an integration network API) and one or more APIs of the cloud platform 215 that are associated with one or more services (e.g., service APIs), which may call endpoints on one or more APIs of the app, for example, via knowledge of the endpoints submitted via application information.

For example, the dynamic control plane may provide a mechanism (e.g., an abstraction layer, a scheme) so multiple application 210 with different implementations, either standard based or proprietary, of each capability (e.g., or any application 210) may be supported by the cloud platform 215. In other words, even when different applications 210 may work differently (e.g., may have APIs with different endpoints, different authentication flows, different credentials and credential formats), the cloud platform 215 may use the dynamic control plane to configure and manage capabilities 220 (e.g., capabilities 220-a, capabilities 220-b, capabilities 220-c) of the applications 210 for the organizations 205. In some examples, the cloud platform 215 may also support one or more public APIs. For example, one or more public APIs may be used for submission of the applications 210 to the cloud platform 215. The dynamic control plane may enable a platform (e.g., any platform) to enable (e.g., directly allow) publishing of the applications 210 to the cloud platform 215, for example, if the platform has (or is otherwise capable of obtaining) application information that satisfies the dynamic control plane. To ensure that the application information (e.g., details of the application 210) satisfies the dynamic control plane, the application information may conform to an application submission template, as well as one or more functionality constraints (e.g., to ensure that feature work as specified). That is, information (e.g., specifications) provided for a capability via the application specification template may (e.g., must) be accurate, such that the cloud platform may implement the capability in accordance with the specified information (e.g., an endpoint for logout may not be provided for an SSO capability).

In some examples, the cloud platform 215 may support an application submission template that enables providers (e.g., identity platforms) to publish (e.g., automatically submit) applications 210 to the cloud platform 215, and enables the cloud platform 215 to configure and manage capabilities 22 of the applications 210, via the dynamic control plane. In some examples, the application submission template may enable developer application platforms to support (e.g., allow) submission of applications 210 to the cloud platform 215 by, for example, providing a custom form (or alternative input mechanisms) for users of the developer application platforms (e.g., developers of the applications) to submit the application information (e.g., in accordance with the application submission template).

A provider of an application 210-a may submit application details to the cloud platform 215 in accordance with the application submission template of the cloud platform 215. The cloud platform 215 may use the application information to publish the application 210-a. In some examples, the provider may be a first party application provider (e.g., another cloud platform associated with the cloud platform 215), or the provider may be a third party application provider (e.g., an ISV, an identity platform, an application developer platform). The cloud platform 215 may implement the application submission template for the provider (e.g., an integrator) or the provider may implement the application submission template themselves. That is, the provider may submit the application information to the cloud platform 215 in accordance with the application submission template, or the cloud platform 215 may (e.g., autonomously) obtain the application information for the application submission template (e.g., on behalf of the provider). In some examples, whether the cloud platform 215 implements the application submission template for the provider or the provider implements the application submission template themselves may be based on one or more factors (e.g., budget, timelines, integrator importance). In some examples, a provider may use an API of the cloud platform 215 (e.g., cloud platform APIs) to submit the application information (e.g., in accordance with the application submission template). The application submission template may provide a mechanism to describe application capabilities and endpoints, as well as content useful for users for the cloud platform 215 to identify the application and its capabilities.

For example, the application information may include (e.g., be indicative of) the capabilities 220-a supported by the application 210-a. In some examples, the application information may include a subset of information for each of the multiple capabilities. A subset of information for a capability may include the capability, a type associated with the capability (e.g., OIDC or SAML for an authorization capability, or SCIM for a provisioning capability). Additionally, or alternatively, a subset of information for a capability may include one or more routes (e.g., a route for authorization, a route for logout) or one or more endpoints from one or more APIs associated with the application 210-a, or both. In some examples, a subset of information for a capability may include one or more credentials (e.g., a client ID, a client secret) and content associated with the application 210-a. In other words, the application information may include one or more endpoints and one or more credentials (among other information), and each endpoint and each credential may be associated with a respective capability. As such, the application information may be usable by users of the cloud platform 215 to identify the application 210 in the cloud platform 215 and to determine (e.g., understand) the capabilities 220-a of the application 210-a.

The cloud platform 215 may review the application information and publish the application 210-a. By publishing the application 210-a, the cloud platform 215 may provide a mechanism for the user to setup the application 210-a (e.g., automatically). For example, after the application 210-a is published on the cloud platform 215, a user of the cloud platform 215 (e.g., an IT administrator) may identify the application 210-a (e.g., in a marketplace, the integration network) and determine information about the application 210-a, such as the capabilities 220-a the application 210-a supports, what the application 210-a may be used for, and how the cloud platform 215 may integrate the application 210-a. That is, the application information may be indicative of capabilities 220-a, routes, endpoints from APIs (e.g., the application 210-a may be associated with multiple APIs and each API may include multiple endpoints), credentials (e.g., clientId, clientSecret), and content associated with the application 210-a.

The user may select the application 210-a (e.g., click a button to configure the application) and may then select which of the capabilities 220-a to set up (might be some or all of the capabilities 220). The cloud platform 215 may redirect the user to login to the application 210-a in accordance with an authentication flow for the application 210-a. The user may successfully login into the application 210-a and may grant the cloud platform 215 access to the application 210-a on its behalf For example, the user may input credentials (e.g., IT admin login credentials) on the application 210-a and may grant access to the cloud platform 215, such that the cloud platform 215 may obtain one or more API credentials (e.g., one or more bearer tokens) with appropriate permissions to configure the selected capabilities in the application 210-a via one or more APIs. In some examples, the cloud platform 215 may determine the one or more APIs based on the application information. The one or more APIs may be hosted by one or more providers (e.g., a company that created the application, a third-party platform).

In some examples, a mechanism used by the cloud platform 215 to obtain the API credential may be based on the provider (e.g., and may be specified via the application information). That is, the cloud platform 215 may implement the mechanism per provider. In some examples, the cloud platform 215 may implement the mechanism via the abstraction layer, for example, using a programming design pattern. The programming design pattern may, in some implementations, be referred to as a “strategy/provider.” As described herein, a programming design pattern may refer to a general, reusable solution to a recurring problem within a given context. The application submission template may be an example of a programming design pattern. For example, the application submission template may be common to multiple (e.g., all) applications and may enable the cloud platform 215 to implement the mechanism per provider. In other words, the application submission template may serve as a provider interface for various types of application platform implementations (e.g., platforms that allow organizations to implement applications such as implementations for identity platforms, implementation for application development platforms) as well as single provider implementations.

The cloud platform 215 may use one of the API credentials to perform capability configuration for the capabilities selected from the capabilities 220-a. That is, the cloud platform 215 may perform capability configuration using the API credential (token) and calling the appropriate provider API endpoints (e.g., API endpoints associated with the selected capabilities of the capabilities 220-a as defined by the application information). As such, configured capabilities 221 may correspond to capabilities selected from among the capabilities 220-a. In some examples, such as for dynamic capabilities, the cloud platform 215 may communicate with the provider (e.g., and the application 210-a) during regular (or irregular) intervals (e.g., during regular or irregular use of the cloud platform 215 by the organization 205-a). Additionally, or alternatively, the provider may communicate with the cloud platform 215 during regular (or irregular) intervals (e.g., during regular or irregular use of the cloud platform 215 by the organization 205-a). For example, an action or event may occur (e.g., in accordance with the configured capability) and, in response, the cloud platform 215 may communicate with the associated API to implement the capability (or one or more features of the capability). That is, the cloud platform 215 may call an appropriate endpoint of the application 210-a to update the application 210-a in accordance with the configured capability. Additionally, or alternatively, the provider may call an appropriate endpoint of the cloud platform 215 in accordance with the configured capability. For example, as part of configuring the capability, the cloud platform 215 may share (e.g., communicate, set) one or more endpoints of the cloud platform 215 that the provider may call to perform one or more actions in accordance with the capability, and may share (e.g., set, communicate) one or more credentials that the provider may use to authenticate the call. In other words, the cloud platforms 215 may perform bidirectional (and dynamic) communications in accordance with one or more of the configured capabilities 221.

An action or event may occur (e.g., take place) that triggers (e.g., necessitates) the cloud platform 215 to communicate with the application 210-a to implement a capability (e.g., a feature, one of the configured capabilities 221). In response, the cloud platform 215 may call the appropriate endpoint to update the application 210-a (e.g., in accordance with the capability). For example, a user of the organization 205-a may be created in the cloud platform 215 and the cloud platform 215 may use a provisioning capability (e.g., with a SCIM implementation) to add the user to the application 210-a by calling an API of the provider that is associated with the provisioning capability. In other examples, a user of the organization 205-a may be granted role (e.g., “writer”) for the application 210-a in the cloud platform 215 and, in response, the cloud platform 215 may call an API of the provider that is associated with a governance capability to configure the role for the user in the application 210-a. In some other examples, a user of the organization 205-a may log out of the application 210-a and, in response, the cloud platform 215 may log the user out of the cloud platform 215 (e.g., out of their session with the cloud platform 215) in accordance with an SLO capability. For example, in accordance with the SLO capability, the provider may send a message to the cloud platform 215 in response to (e.g., when) the user signs out of the application 210-a (e.g., may call an API endpoint of the cloud platform 215 that is associated with SLO), which may trigger the cloud platform 215 to log the user out of the cloud platform 215. In some examples, to enable the SLO capability, the cloud platform 215 may share (e.g., pass) SLO configuration information (e.g., the API endpoint of the cloud platform 215 that is associated with SLO and a credential for authenticating the call) to the provider during setup (e.g., during configuration of the SLO capability), such that the provider may properly sign the SLO message (e.g., using the credential).

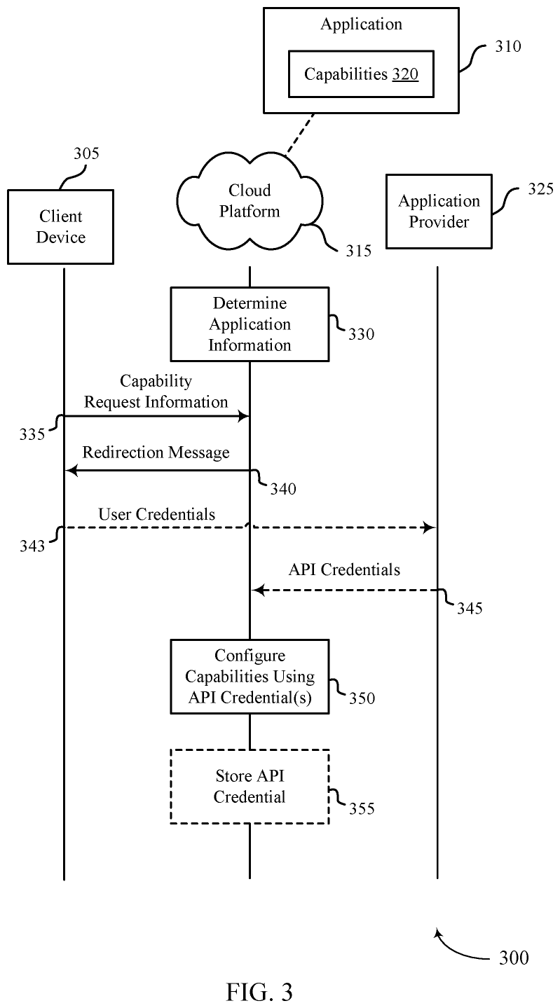

FIG. 3 shows an example of a process flow 300 that enables a dynamic control plane for configuring and managing capabilities across applications via a cloud platform in accordance with aspects of the present disclosure. In some examples, the process flow 300 may implement aspects of the system 100 and the block diagram 200. For example, the process flow 300 may illustrate operations at a client device 305, which may each be an example of a client device 105 illustrated by and described with reference to FIG. 1. The process flow 300 may also include a cloud platform 315, which may be an example of a cloud platform (e.g., an identity management platform) illustrated by and described with reference to FIGS. 1 and 2. The process flow may further include an application provider 325, which may be an example of an application provider 140 illustrated by and described with reference to FIG. 1. The process flow 300 may be implemented at the cloud platform 315, the client device 305, the application provider 325, or any combination thereof. In the following description of the process flow 300, the operations performed at the cloud platforms 315 and the client devices 305 may be performed in different orders or at different times than shown. Additionally, or alternatively, some operations may be omitted from the process flow 300 and other operations may be added to the process flow 300. In some examples, the cloud platform 315 may support a framework for configuring and managing applications over a duration of time (e.g., dynamically). For example, the cloud platform 315 may enable organizations (e.g., or other types of customers) of the cloud platform 315 to manage user identities (e.g., identities of the users) and access to one or more accounts of applications that correspond to (e.g., are associated with, belong to) the organization via the cloud platform 315. Additionally, the cloud platform 315 may manage capabilities of the applications for the organization (e.g., dynamically). In other words, the cloud platform 315 may support a method for configuring and managing (e.g., dynamically) applications over time.

At 330, the cloud platform 315 may determine application information for an application 310. In some examples, the cloud platform 315 may determine the application information by obtaining the application information from an ISV of the application 310, an application platform used for developing the application 310, or an IdP used by the application 310 (e.g., used by the application provider 325). For a single provider implementation (e.g., in the case of an ISV), the cloud platform 315 may determine the application information itself, a developer of the application may determine the application information and input the application information into the cloud platform 315 via a form or API (or another method for submitting). For a platform implementation (e.g., in the case of an application development platform or an identity platform) the platform may submit the application information via an API. For example, an identity platform may submit the application information directly via an API of the cloud platform 315. One or more other types of platforms (e.g., an application development platform or another type of application platform) may request routes (among other details) to determine the application information and may then submit the determined application information to the cloud platform 315 via an API of the cloud platform 315. In other words, different types of platforms may provide for (e.g., directly allow) publishing of applications (e.g., applications associated with the platforms) to the cloud platform 315 if, for example, the platforms possess (or may otherwise be capable of providing to the cloud platform 315) details to satisfy the application specification template. Various types of platforms may include platforms used to host or build an application or platforms used to manage user identities or other types of sensitive information for applications, among other examples of software platforms. For example, the application specification template may support a single provider implementation, a general application platform implementation, and an identity platform implementation, among other examples. In some examples, the cloud platform 315 may obtain the application information from the application provider 325 via a message, such as a form submitted to the cloud platform 315, or an email output to the cloud platform 315, among other types of messages. It is to be understood that the types of message listed herein are example messages and other types of messages are not precluded. The examples described herein should not be considered limiting to the scope covered by the claims or the disclosure. Additionally, or alternatively, the cloud platform 315 may obtain the application information via an API of the cloud platform 315 that is associated with the application provider 325 (e.g., a cloud platform API for the application provider 325).

The application 310 and the capabilities 320 may be examples of an application 210 and capabilities 220, respectively, as described with reference to FIG. 2. For example, the cloud platform 315 may support a mechanism to describe application capabilities and endpoints, as well as descriptive/identification content for various applications, such as the application 310. The application information may be obtained in accordance with an application specification template, which may be an example of an application specification template illustrated by and described with reference to FIG. 2. For example, the application specification template may be common to multiple applications (e.g., multiple types of applications, applications from multiple types of providers). The cloud platform 315 may use the application information for configuring and managing the capabilities 320. That is, the application information may be used for initial configuration and to enact the capabilities 320 of the application 310 (e.g., to perform one or more actions in accordance with the capabilities 320).

In some examples, the application information may be indicative of the capabilities 320, one or more endpoints from one or more APIs, one or more credentials, and content associated with the application 310. In some examples, each endpoint and each credential may be associated with a respective capability of the capabilities 320. In other words, different capabilities may have different APIs, and one or more endpoints may belong to each API. For example, in accordance with the application specification template, the application information may include separate information (e.g., a capability type, one or more routes, one or more endpoints, one or more credentials) for each capability. The capabilities 320 may include SSO, one or more secure session management capabilities (e.g., SLO, confidence score level based MFA management, and confidence score level based permissions management), provisioning, identity governance and access, lifecycle management, and risk signaling, among other types of capabilities. It is to be understood that the capabilities listed herein are example capabilities and other types of capabilities are not precluded. The examples described herein should not be considered limiting to the scope covered by the claims or the disclosure.

As described herein, provisioning may refer to a capability that uses a protocol (e.g., SCIM) to synchronize user account information between a user store and an external application (e.g., the application 310). Provisioning may include setting up new users and teams. In some examples, in accordance with a provisioning capability, the cloud platform 315 may create, read, and update user accounts for new or existing users, remove accounts for deactivated users, and synchronize attributes across multiple user stores. In some examples, provisioning and deprovisioning actions may be bi-directional, for example, so a user can create accounts inside an external application and import them into the cloud platform 315. Additionally, or alternatively, in accordance with a provisioning capability, the cloud platform 315 may create accounts in the cloud platform 315 and push the accounts out to one or more external applications (e.g., any integrated external application, such as the application 310). As described herein governance management may refer to a capability that enables security administrators to manage user identities and access across enterprises. In some examples, governance may include integration of policies, procedures, and technologies for managing digital identities and privileges (e.g., access rights). As described herein access management may refer to a capability that enables organizations to manage and control access to resources of the organization, such as applications, systems, and data. As described herein, lifecycle management may refer to a capability that enables management of a software application from initial planning and development, through testing and maintenance, and into decommissioning and retirement. As described herein, risk signaling may refer to sharing of risk signals across networks, locations, and devices to identify deviations from normal user login patterns. In some examples, a risk signal (or score) may refer to a metric that is indicative of a potential security risk (e.g., threat, vulnerability) associated with a user, network, location, or device, among other examples. For example, a risk score may be based on data collected by one or both of the cloud platforms and may be indicative of whether an event (e.g., a sign-in event) is likely to represent malicious activity. In some examples, a risk score or level may be assigned based on an IP address associated with the event (e.g., the IP address used to make the sign-in request), behavioral information about a user associated with the event, previous events associated with the user (e.g., previous successful and failed sign-in attempts), or routing information associated with the event, among other examples of information that may be obtained by the cloud platform 315. As described herein, SSM may refer to a capability for processing and handling multiple requests to a web-based application or service from a single user or entity. For example, the SSM capabilities may include single-log-out (SLO), a confidence score level based MFA management capability (e.g., a dynamic, confidence score level based MFA capability), and a confidence score level based permissions management capability (e.g., a dynamic confidence score level based permissions management capability). For example, the application 310 may support a capability in which MFA constraints (e.g., MFA requirements) or permissions, or both, may be based on a confidence level. In some examples, the confidence level may be static (i.e., the confidence level may be calculated once) or the confidence level may be dynamic (e.g., the confidence level may be re-calculated over time). In some examples, if the confidence level changes dynamically, the permissions or MFA constraints may also change dynamically. That is, as the confidence level changes the MFA constraints or permissions, or both, for the application 310 may change. In some examples, MFA constraints (e.g., MFA requirements) may change based on risk signals, or permissions may change (e.g., permissions may be granted or removed) based on anomalous behaviors. It is to be understood that the capabilities listed herein are example capabilities and other types of capabilities are not precluded. The examples described herein should not be considered limiting to the scope covered by the claims or the disclosure.

In some examples, the application information may be usable by the first user to identify the application 310 in the cloud platform 315 and to determine the capabilities 320 of the application 310. In other words, the application information may include capabilities, endpoints from APIs, credentials, and content so that users of the cloud platform 315 may identify the application 310 and understand the capabilities the application 310 provides. For example, the cloud platform 315 may publish the application 310 via the cloud platform 315 in accordance with the application information, which may enable the users of the cloud platform 315 to find and identify the application 310 in the cloud platform 315 (e.g., in an integration network of the cloud platform 315) and understand the capabilities 320 that the application 310 provides. As described herein, publishing an application on the cloud platform 315 may refer to making the application 310 available for configuration by users (e.g., customers) of the cloud platform 315 that have an account on the application 310. In some examples, by publishing the application 310 in the cloud platform 315 in accordance with the application specification template, users may configure the application 310 (e.g., for use via the organization) relatively easily. For example, publishing the application 310 to the cloud platform 215 using the application specification template may allow for increased accessibility, relatively easier configuration, and may enable a dynamic control plane.

In some other examples, the cloud platform 315 may determine the application information itself (e.g., autonomously). For example, the cloud platform 315 (e.g., an employee of the cloud platform 315 or an automated service configured at the cloud platform 315) may determine (e.g., identity, figure out, or otherwise obtain) the application information and structure the obtained information in accordance with the application specification template (e.g., may fill out the application specification template). In some examples, the cloud platform 315 may have one or more mechanisms for automatically determining the information (e.g., via automated crawlers) or an employee of the cloud platform 315 may collect the information (e.g., manually, or semi-automatically), or some combination thereof.

At 335, the cloud platform 315 may obtain capability request information from a first user (e.g., via the client device 305) of the cloud platform 315. The first user may be associated with an organization (e.g., tenant) of the cloud platform 315, and the organization may have an account with the application 310. The capability request information may include a first request to configure the application 310 for the account of the application 310 (e.g., an account associated with the first user, such as the organization of the first user) and may include a second request to configure a set of capabilities selected from among the capabilities 320 of the application 310. For example, within the cloud platform 315, the first user (e.g., an IT administrator) may select to set up an integration for the application 310 (e.g., an application that the first user has a subscription, account, or tenant on). In some examples, the capability request information may also include an indication of the account. In some other examples, the first user may indicate the account in accordance with an authentication flow for the application 310. For example, the application provider 325 may also manage an authentication flow for the application 310. In such an example, the first user may indicate (e.g., select) the account as part of the authentication flow. For example, the first user may have multiple accounts (e.g., 3 or some other suitable quantity of accounts) with the application 310 and may select one of the multiple accounts (e.g., which of the multiple accounts) to grant access to as part of the application authentication flow (e.g., login flow). In some examples, the cloud platform 315 may obtain the capability request information from the first user based on the application 310 being published in the cloud platform 315. That is, the first user may identify (e.g., find) the application 310 in the cloud platform 315 after the application 310 has been published (e.g., in accordance with the application information).

At 340, the cloud platform 315 may redirect the first user to authenticate the first user for access to the application 310. For example, the cloud platform 315 (e.g., a redirector) may transmit a message (e.g., a redirect message) to the first user (e.g., the client device 305). In some examples, the first user may authenticate with the application provider 325. I

For example, at 343 in response to the redirection message, the client device 305 may submit (e.g., enter) user credentials to the application provider 325 and may grant the cloud platform 315 access to one or more APIs of the application on behalf of the first user. In some examples, the cloud platform 315 may transmit the redirection message in accordance with an authentication flow for the application 310. For example, the cloud platform 315 may be configured with (e.g., or otherwise implement) an authentication flow for the application 310 and may redirect the user in accordance with the authentication flow. In some examples, the cloud platform 315 may redirect the first user to the application provider 325 (or to an IdP used by the application provider 325). For example, the cloud platform 315 may redirect the first user to a login (or other type of authentication mechanism) for the application 310. In such an example, the first user may input one or more user credentials (e.g., their IT admin credentials) and may grant the cloud platform 315 access to the application 310 (e.g., for the account or for the user profile of the account). In some examples, by granting access to the cloud platform 315, the cloud platform 315 may obtain one or more API credentials (e.g., one or more bearer tokens) with appropriate permissions to configure and manage the selected capabilities in the application 310 via one or more APIs of the application 310 (e.g., which may be hosted by the application provider 325 or one or more other types of provides).

In some examples, at 345, the cloud platform 315 may obtain the one or more API credentials from the application provider 325. For example, the first user may be successfully authenticated and, as such, the application provider 325 of the application 310 (or another entity that may manage access to the application 310) may grant the API credentials (e.g., bearer tokens) to the cloud platform 315. The cloud platform 315 may use the API credentials to authenticate with one or more APIs related to the application 310. In some examples, each API credential may be associated with one or more permissions that enable the cloud platform 315 to configure and manage the set of capabilities of the application 310 for the account via the application provider 325. That is, the API credential may be associated with a set of permissions that enables the cloud platform 315 to configure (e.g., manage, setup) the set of capabilities selected from among the capabilities 320 in the application 310 via the cloud platform 315. In other words, the API credential enables the cloud platform 315 to configure the set of capabilities in the application 310 via the application provider 325. In some examples, the cloud platform 315 may obtain the API credentials that are associated with the one or more permissions based on the account being granted the one or more permissions. That is, the account indicated via the capability request information (or via the authentication flow) may be associated with one or more permissions, which may correspond to the same one or more permissions associated with each API credential. In other words, the cloud platform 315 may obtain an API credential with appropriate permissions based on the account.

At 350, the cloud platform 315 may configure the set of capabilities in the application 310 via one or more API calls from the cloud platform 315 to one or more endpoints of the application provider 325. The one or more API calls may be authenticated via one or more of the API credentials in accordance with the application information. In other words, the cloud platform 315 may perform a capability configuration using a API credential (e.g., token) and calling the appropriate (e.g., associated, corresponding) APIs (based on the application information).

In some examples, the cloud platform 315 may use one of the API credentials it obtains to renew another one of the API credentials. For example, the cloud platform 315 may determine to configure SSO (e.g., based on the first user selecting an SSO capability). In such an example, at 345, the cloud platform 315 may obtain two API credentials in which a first one of the API credentials may be for SSO configuration. In some examples, the first API credential may be associated with a lifetime. For example, the first API credential may expire in 30 days (or some other suitable time). Accordingly, a second one of the API credentials may allow the cloud platform 315 to renew the first API credential. In some examples, the API credentials may be associated with a pattern for renewal.

In some examples, at 355, the cloud platform 315 may store the credentials (e.g., for future use). For example, the cloud platform 315 may store the credentials for performing one or more actions in accordance with one or more of the set of capabilities. That is, the cloud platform 315 may use the stored credential to dynamically update the application 310 (e.g., in accordance with one or more of the configured capabilities). For example, the cloud platform 315 may obtain an indication that triggers the cloud platform 315 to perform an action in accordance with a capability. In some examples, the indication may include a request to create a user (e.g., a provisioning request), a request to configure a role for a user (e.g., a governance request), or a message indicating that the first user logged out of the application 310 (e.g., an SLO request). The cloud platform 315 may, in response to the indication, output one or more API calls via an API that is associated with the capability. The one or more API calls may be authenticated via the stored credential. For example, the cloud platform may output one or more calls via an API associated with the provisioning capability in response to a provisioning request, one or more calls via an API associated with a governance capability in response to the governance request, or one or more calls via an API associated with an SLO capability in response to the SLO request. That is, the cloud platform 315 may communicate with the application 310 to implement a capability (e.g., a feature of a capability) by calling the appropriate provider endpoint to update the application 310. In some examples, more than one API call may be used to act on a trigger (e.g., in response to an indication). The API may be based on (e.g., indicated via) the application information. For example, the API may include an endpoint indicated via the application information.

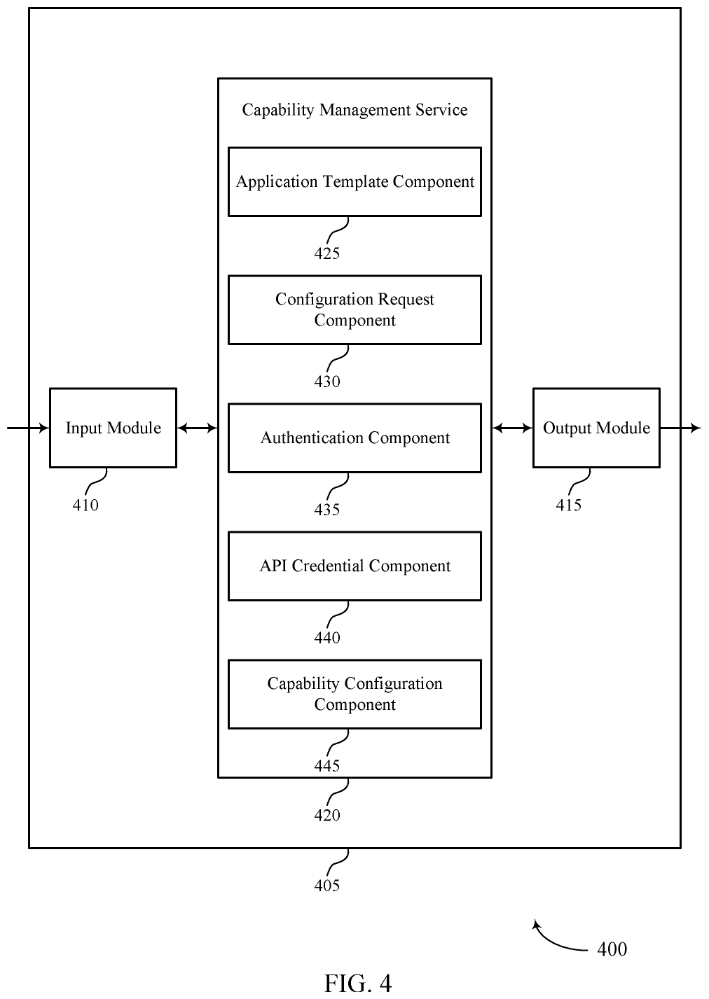

FIG. 4 shows a block diagram 400 of a device 405 that supports a dynamic control plane for configuring capabilities across applications via a cloud platform in accordance with aspects of the present disclosure. The device 405 may include an input module 410, an output module 415, and a capability management service 420. The device 405, or one or more components of the device 405 (e.g., the input module 410, the output module 415, and the capability management service 420), may include at least one processor, which may be coupled with at least one memory, to support the described techniques. Each of these components may be in communication with one another (e.g., via one or more buses).

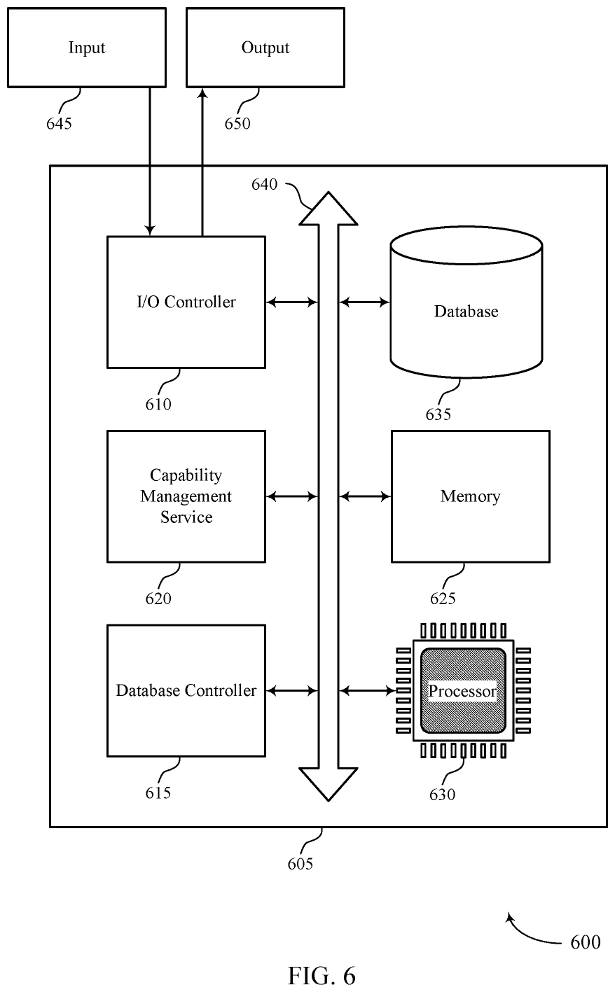

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the capability management service 420 to support a dynamic control plane for configuring capabilities across applications via a cloud platform. In some cases, the input module 410 may be a component of an I/O controller 610 as described with reference to FIG. 6.

The output module 415 may manage output signals for the device 405. For example, the output module 415 may receive signals from other components of the device 405, such as the capability management service 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the capability management service 420 may include an application template component 425, a configuration request component 430, an authentication component 435, an API credential component 440, a capability configuration component 445, or any combination thereof. In some examples, the capability management service 420, or various components thereof, may be configured to perform various operations (e.g., receiving, monitoring, transmitting) using or otherwise in cooperation with the input module 410, the output module 415, or both. For example, the capability management service 420 may receive information from the input module 410, send information to the output module 415, or be integrated in combination with the input module 410, the output module 415, or both to receive information, transmit information, or perform various other operations as described herein.

The capability management service 420 may support configuring and managing applications from a cloud platform over a duration of time in accordance with examples as disclosed herein. The application template component 425 may be configured to support determining first information for an application associated with a set of multiple capabilities, where the first information is determined in accordance with an application specification template that is common to a set of multiple applications, and where the first information is usable by the cloud platform for configuring and managing the set of multiple capabilities via the cloud platform. The configuration request component 430 may be configured to support obtaining second information from a first user of the cloud platform, where the second information includes a first request to configure the application for an account of the application that is associated with the first user, and includes a second request to configure a subset of capabilities of the application, the subset of capabilities selected from among the set of multiple capabilities. The authentication component 435 may be configured to support redirecting the first user to authenticate the first user to obtain access to the application in accordance with an authentication flow for the application. The API credential component 440 may be configured to support obtaining third information in response to redirecting the first user, where the third information includes a credential to authenticate with one or more APIs related to the application, where the credential is associated with one or more permissions that enable the cloud platform to configure and manage the set of capabilities of the application for the account via a provider of the application. The capability configuration component 445 may be configured to support configuring the set of capabilities in the application via one or more API calls from the cloud platform to one or more endpoints of the provider, where the one or more API calls are authenticated via the credential in accordance with the first information.

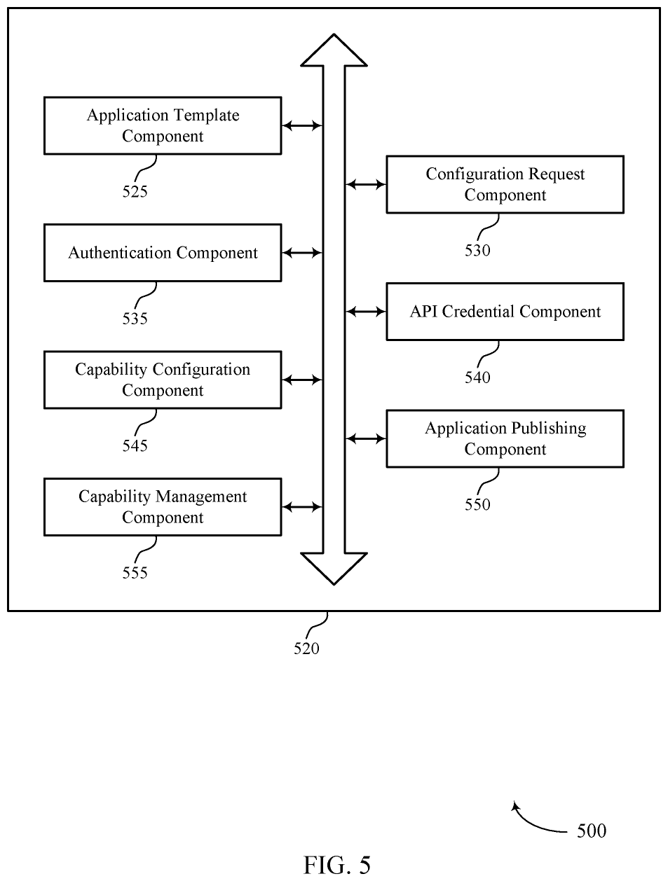

FIG. 5 shows a block diagram 500 of a capability management service 520 that supports a dynamic control plane for configuring capabilities across applications via a cloud platform in accordance with aspects of the present disclosure. The capability management service 520 may be an example of aspects of a capability management service or a capability management service 420, or both, as described herein. The capability management service 520, or various components thereof, may be an example of means for performing various aspects of dynamic control plane for configuring capabilities across applications via a cloud platform as described herein. For example, the capability management service 520 may include an application template component 525, a configuration request component 530, an authentication component 535, an API credential component 540, a capability configuration component 545, an application publishing component 550, a capability management component 555, or any combination thereof. Each of these components, or components of subcomponents thereof (e.g., one or more processors, one or more memories), may communicate, directly or indirectly, with one another (e.g., via one or more buses).

The capability management service 520 may support configuring and managing applications from a cloud platform over a duration of time in accordance with examples as disclosed herein. The application template component 525 may be configured to support determining first information for an application associated with a set of multiple capabilities, where the first information is determined in accordance with an application specification template that is common to a set of multiple applications, and where the first information is usable by the cloud platform for configuring and managing the set of multiple capabilities via the cloud platform. The configuration request component 530 may be configured to support obtaining second information from a first user of the cloud platform, where the second information includes a first request to configure the application for an account of the application that is associated with the first user, and includes a second request to configure a subset of capabilities of the application, the subset of capabilities selected from among the set of multiple capabilities. The authentication component 535 may be configured to support redirecting the first user to authenticate the first user to obtain access to the application in accordance with an authentication flow for the application. The API credential component 540 may be configured to support obtaining third information in response to redirecting the first user, where the third information includes a credential to authenticate with one or more APIs related to the application, where the credential is associated with one or more permissions that enable the cloud platform to configure and manage the set of capabilities of the application for the account via a provider of the application. The capability configuration component 545 may be configured to support configuring the set of capabilities in the application via one or more API calls from the cloud platform to one or more endpoints of the provider, where the one or more API calls are authenticated via the credential in accordance with the first information.

In some examples, the API credential component 540 may be configured to support storing the credential at the cloud platform for performing at least an action in accordance with at least a capability of the set of capabilities. In some examples, the capability management component 555 may be configured to support obtaining an indication that triggers the cloud platform to perform the action in accordance with the capability. In some examples, the API credential component 540 may be configured to support outputting, in response to the indication, at least an API call via an API that is associated with the capability, where the API includes an endpoint of the one or more endpoints, and where the API call is authenticated via the stored credential.

In some examples, the second information further includes an indication of the account. In some examples, obtaining the credential that is associated with the one or more permissions is based on the account being granted the one or more permissions. In some examples, the first information is indicative of the set of multiple capabilities, a set of multiple endpoints from a set of multiple APIs, a set of multiple credentials, and content associated with the application. In some examples, the first information is usable by the first user to identify the application in the cloud platform and to determine the set of multiple capabilities of the application.

In some examples, each endpoint of the set of multiple endpoints and each credential of the set of multiple credentials are associated with a respective capability of the set of multiple capabilities. In some examples, the application publishing component 550 may be configured to support publishing the application via the cloud platform in accordance with the first information, where receiving the second information is based on the application being published.

In some examples, the set of multiple capabilities includes an SSO capability, one or more secure session management capabilities, a provisioning capability, an identity governance and access capability, a lifecycle management capability, and a risk signaling capability. In some examples, the one or more secure session management capabilities includes an SLO capability, a confidence score level based multi-factor authentication management capability, and a confidence score level based permissions management capability.

In some examples, the first information is obtained from a developer of the application, an application platform used for developing the application, or an identity platform used by the application. In some examples, the first information is autonomously obtained at the cloud platform.

In some examples, to support obtaining the first information, the application template component 525 may be configured to support obtaining a message indicative of the first information. In some examples, the message is obtained via a first API of the cloud platform that is associated with the provider. In some examples, the message includes a form submitted to the cloud platform or an email output to the cloud platform.

FIG. 6 shows a diagram of a system 600 including a device 605 that supports a dynamic control plane for configuring capabilities across applications via a cloud platform in accordance with aspects of the present disclosure. The device 605 may be an example of or include the components of a device 405 as described herein. The device 605 may include components for bi-directional voice and data communications including components for transmitting and receiving communications, such as a capability management service 620, an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and ROM. The memory 625 may store computer-readable, computer-executable software including instructions that, when executed, cause at least one processor 630 to perform various functions described herein. In some cases, the memory 625 may contain, among other things, a BIOS which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting a dynamic control plane for configuring capabilities across applications via a cloud platform). The processor 630 may be an example of a single processor or multiple processors. For example, the device 605 may include one or more processors 630.

The capability management service 620 may support configuring and managing applications from a cloud platform over a duration of time in accordance with examples as disclosed herein. For example, the capability management service 620 may be configured to support determining first information for an application associated with a set of multiple capabilities, where the first information is determined in accordance with an application specification template that is common to a set of multiple applications, and where the first information is usable by the cloud platform for configuring and managing the set of multiple capabilities via the cloud platform. The capability management service 620 may be configured to support obtaining second information from a first user of the cloud platform, where the second information includes a first request to configure the application for an account of the application that is associated with the first user, and includes a second request to configure a subset of capabilities of the application, the subset of capabilities selected from among the set of multiple capabilities. The capability management service 620 may be configured to support redirecting the first user to authenticate the first user to obtain access to the application in accordance with an authentication flow for the application. The capability management service 620 may be configured to support obtaining third information in response to redirecting the first user, where the third information includes a credential to authenticate with one or more APIs related to the application, where the credential is associated with one or more permissions that enable the cloud platform to configure and manage the set of capabilities of the application for the account via a provider of the application. The capability management service 620 may be configured to support configuring the set of capabilities in the application via one or more API calls from the cloud platform to one or more endpoints of the provider, where the one or more API calls are authenticated via the credential in accordance with the first information.

By including or configuring the capability management service 620 in accordance with examples as described herein, the device 605 may support techniques for improved user experience related to reduced processing and improved utilization of processing capability.

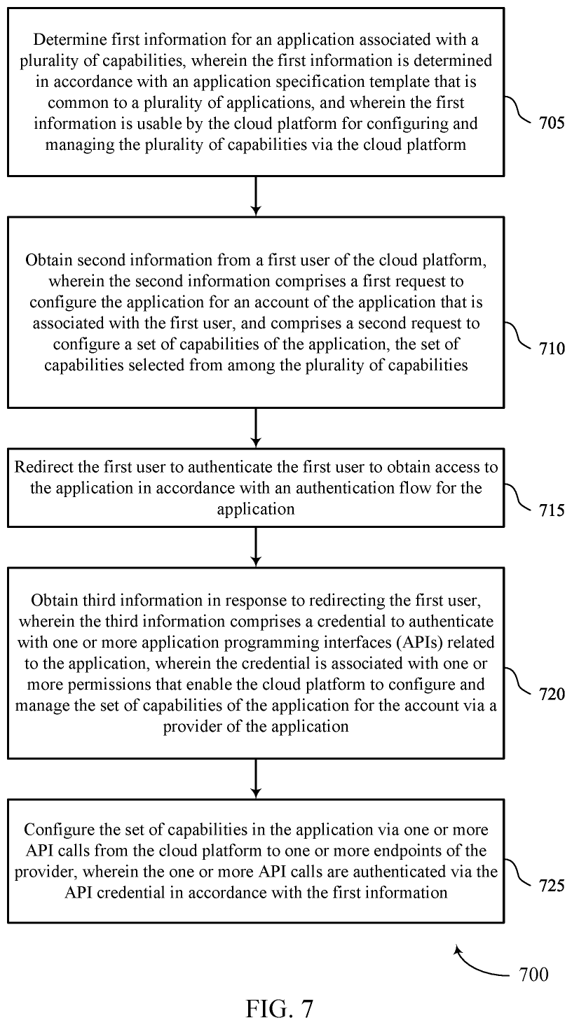

FIG. 7 shows a flowchart illustrating a method 700 that supports a dynamic control plane for configuring capabilities across applications via a cloud platform in accordance with aspects of the present disclosure. The operations of the method 700 may be implemented by an Okta Device or its components as described herein. For example, the operations of the method 700 may be performed by an Okta Device as described with reference to FIGS. 1 through 6. In some examples, an Okta Device may execute a set of instructions to control the functional elements of the Okta Device to perform the described functions. Additionally, or alternatively, the Okta Device may perform aspects of the described functions using special-purpose hardware.

At 705, the method may include determining first information for an application associated with a plurality of capabilities, wherein the first information is determined in accordance with an application specification template that is common to a plurality of applications, and wherein the first information is usable by the cloud platform for configuring and managing the plurality of capabilities via the cloud platform. The operations of block 705 may be performed in accordance with examples as disclosed herein. In some examples, aspects of the operations of 705 may be performed by an application template component 525 as described with reference to FIG. 5.

At 710, the method may include obtaining second information from a first user of the cloud platform, wherein the second information comprises a first request to configure the application for an account of the application that is associated with the first user, and comprises a second request to configure a set of capabilities of the application, the set of capabilities selected from among the plurality of capabilities. The operations of block 710 may be performed in accordance with examples as disclosed herein. In some examples, aspects of the operations of 710 may be performed by a configuration request component 530 as described with reference to FIG. 5.

At 715, the method may include redirecting the first user to authenticate the first user to obtain access to the application in accordance with an authentication flow for the application. The operations of block 715 may be performed in accordance with examples as disclosed herein. In some examples, aspects of the operations of 715 may be performed by an authentication component 535 as described with reference to FIG. 5.

At 720, the method may include obtaining third information in response to redirecting the first user, wherein the third information comprises a credential to authenticate with one or more APIs related to the application, wherein the credential is associated with one or more permissions that enable the cloud platform to configure and manage the set of capabilities of the application for the account via a provider of the application. The operations of block 720 may be performed in accordance with examples as disclosed herein. In some examples, aspects of the operations of 720 may be performed by an API credential component 540 as described with reference to FIG. 5.

At 725, the method may include configuring the set of capabilities in the application via one or more API calls from the cloud platform to one or more endpoints of the provider, wherein the one or more API calls are authenticated via the credential in accordance with the first information. The operations of block 725 may be performed in accordance with examples as disclosed herein. In some examples, aspects of the operations of 725 may be performed by a capability configuration component 545 as described with reference to FIG. 5.

The following provides an overview of aspects of the present disclosure:

Aspect 1: A method for configuring and managing applications from a cloud platform over a duration of time, comprising: determining first information for an application associated with a plurality of capabilities, where the first information is determined in accordance with an application specification template that is common to a plurality of applications, and where the first information is usable by the cloud platform for configuring and managing the plurality of capabilities via the cloud platform; obtaining second information from a first user of the cloud platform, where the second information comprises a first request to configure the application for an account of the application that is associated with the first user, and comprises a second request to configure a subset of capabilities of the application, the subset of capabilities selected from among the plurality of capabilities; redirecting the first user to authenticate the first user to obtain access to the application in accordance with an authentication flow for the application; obtaining third information in response to redirecting the first user, where the third information comprises a credential to authenticate with one or more APIs related to the application, where the credential is associated with one or more permissions that enable the cloud platform to configure and manage the subset of capabilities of the application for the account via a provider of the application; and configuring the subset of capabilities in the application via one or more API calls from the cloud platform to one or more endpoints of the provider, where the one or more API calls are authenticated via the credential in accordance with the first information.

Aspect 2: The method of aspect 1, further comprising: storing the credential at the cloud platform for performing at least an action in accordance with at least a capability of the subset of capabilities.

Aspect 3: The method of aspect 2, further comprising: obtaining an indication that triggers the cloud platform to perform the action in accordance with the capability; and outputting, in response to the indication, at least an API call via an API that is associated with the capability, wherein the API comprises an endpoint of the one or more endpoints, and wherein the API call is authenticated via the stored credential.

Aspect 4: The method of any of aspects 1 through 3, wherein the second information further comprises an indication of the account, and obtaining the credential that is associated with the one or more permissions is based at least in part on the account being granted the one or more permissions.

Aspect 5: The method of any of aspects 1 through 4, wherein the first information is indicative of the plurality of capabilities, a plurality of endpoints from a plurality of APIs, a plurality of credentials, and content associated with the application, the first information is usable by the first user to identify the application in the cloud platform and to determine the plurality of capabilities of the application.

Aspect 6: The method of aspect 5, wherein each endpoint of the plurality of endpoints and each credential of the plurality of credentials are associated with a respective capability of the plurality of capabilities.

Aspect 7: The method of any of aspects 1 through 6, further comprising: publishing the application via the cloud platform in accordance with the first information, wherein receiving the second information is based at least in part on the application being published.

Aspect 8: The method of any of aspects 1 through 7, wherein the plurality of capabilities includes a single-sign-on capability, one or more secure session management capabilities, a provisioning capability, an identity governance and access capability, a lifecycle management capability, and a risk signaling capability.

Aspect 9: The method of aspect 8, wherein the one or more secure session management capabilities includes a single-log-out capability, a confidence score level based multi-factor authentication management capability, and a confidence score level based permissions management capability.

Aspect 10: The method of any of aspects 1 through 9, wherein the first information is obtained from a developer of the application, an application platform used for developing the application, or an identity platform used by the application.

Aspect 11: The method of any of aspects 1 through 9, wherein the first information is autonomously obtained at the cloud platform.

Aspect 12: The method of any of aspects 1 through 9, wherein obtaining the first information comprises: obtaining a message indicative of the first information.

Aspect 13: The method of aspect 12, wherein the message is obtained via a first API of the cloud platform that is associated with the provider.

Aspect 14: The method of aspect 12, wherein the message comprises a form submitted to the cloud platform or an email output to the cloud platform.

Aspect 15: An apparatus for configuring and managing applications from a cloud platform over a duration of time, comprising one or more memories storing processor-executable code, and one or more processors coupled with the one or more memories and individually or collectively operable to execute the code to cause the apparatus to perform a method of any of aspects 1 through 14.

Aspect 16: An apparatus for configuring and managing applications from a cloud platform over a duration of time, comprising at least one means for performing a method of any of aspects 1 through 14.

Aspect 17: A non-transitory computer-readable medium storing code for configuring and managing applications from a cloud platform over a duration of time, the code comprising instructions executable by a processor to perform a method of any of aspects 1 through 14.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for configuring and managing applications from a cloud platform over a duration of time, comprising:
determining first information for an application associated with a plurality of capabilities, wherein the first information is determined in accordance with an application specification template that is common to a plurality of applications, and wherein the first information is usable by the cloud platform for configuring and managing the plurality of capabilities via the cloud platform;
obtaining second information from a first user of the cloud platform, wherein the second information comprises a first request to configure the application for an account of the application that is associated with the first user, and comprises a second request to configure a set of capabilities of the application, the set of capabilities selected from among the plurality of capabilities;
redirecting the first user to authenticate the first user to obtain access to the application in accordance with an authentication flow for the application;
obtaining third information in response to redirecting the first user, wherein the third information comprises a credential to authenticate with one or more application programming interfaces (APIs) related to the application, wherein the credential is associated with one or more permissions that enable the cloud platform to configure and manage the set of capabilities of the application for the account via a provider of the application; and
configuring the set of capabilities in the application via one or more API calls from the cloud platform to one or more endpoints of the provider, wherein the one or more API calls are authenticated via the credential in accordance with the first information.

2. The method of claim 1, further comprising:
storing the credential at the cloud platform for performing at least an action in accordance with at least a capability of the set of capabilities.

3. The method of claim 2, further comprising:
obtaining an indication that triggers the cloud platform to perform the action in accordance with the capability; and
outputting, in response to the indication, at least an API call via an API that is associated with the capability, wherein the API comprises an endpoint of the one or more endpoints, and wherein the API call is authenticated via the stored credential.

4. The method of claim 1, wherein the second information further comprises an indication of the account, and obtaining the credential that is associated with the one or more permissions is based at least in part on the account being granted the one or more permissions.

5. The method of claim 1, wherein the first information is indicative of the plurality of capabilities, a plurality of endpoints from a plurality of APIs, a plurality of credentials, and content associated with the application, and the first information is usable by the first user to identify the application in the cloud platform and to determine the plurality of capabilities of the application.

6. The method of claim 5, wherein each endpoint of the plurality of endpoints and each credential of the plurality of credentials are associated with a respective capability of the plurality of capabilities.

7. The method of claim 1, further comprising:
publishing the application via the cloud platform in accordance with the first information, wherein receiving the second information is based at least in part on the application being published.

8. The method of claim 1, wherein the plurality of capabilities includes a single-sign-on capability, one or more secure session management capabilities, a provisioning capability, an identity governance and access capability, a lifecycle management capability, and a risk signaling capability.

9. The method of claim 8, wherein the one or more secure session management capabilities includes a single-log-out capability, a confidence score level based multi-factor authentication management capability, and a confidence score level based permissions management capability.

10. The method of claim 1, wherein the first information is obtained from a developer of the application, an application platform used for developing the application, or an identity platform used by the application.

11. The method of claim 1, wherein the first information is autonomously obtained at the cloud platform.

12. The method of claim 1, wherein determining the first information comprises:
obtaining a message indicative of the first information.

13. The method of claim 12, wherein the message is obtained via a first API of the cloud platform that is associated with the provider.

14. The method of claim 12, wherein the message comprises a form submitted to the cloud platform or an email output to the cloud platform.

15. An apparatus for configuring and managing applications from a cloud platform over a duration of time, comprising:
one or more memories storing processor-executable code; and
one or more processors coupled with the one or more memories and individually or collectively operable to execute the code to cause the apparatus to:
determine first information for an application associated with a plurality of capabilities, wherein the first information is determined in accordance with an application specification template that is common to a plurality of applications, and wherein the first information is usable by the cloud platform for configuring and managing the plurality of capabilities via the cloud platform;
obtain second information from a first user of the cloud platform, wherein the second information comprises a first request to configure the application for an account of the application that is associated with the first user, and comprises a second request to configure a set of capabilities of the application, the set of capabilities selected from among the plurality of capabilities;
redirect the first user to authenticate the first user to obtain access to the application in accordance with an authentication flow for the application;
obtain third information in response to redirecting the first user, wherein the third information comprises a credential to authenticate with one or more application programming interfaces (APIs) related to the application, wherein the credential is associated with one or more permissions that enable the cloud platform to configure and manage the set of capabilities of the application for the account via a provider of the application; and
configure the set of capabilities in the application via one or more API calls from the cloud platform to one or more endpoints of the provider, wherein the one or more API calls are authenticated via the credential in accordance with the first information.

16. The apparatus of claim 15, wherein the one or more processors are individually or collectively further operable to execute the code to cause the apparatus to:
store the credential at the cloud platform for performing at least an action in accordance with at least a capability of the set of capabilities.

17. The apparatus of claim 16, wherein the one or more processors are individually or collectively further operable to execute the code to cause the apparatus to:
obtain an indication that triggers the cloud platform to perform the action in accordance with the capability; and
output, in response to the indication, at least an API call via an API that be associated with the capability, wherein the API comprises an endpoint of the one or more endpoints, and wherein the API call is authenticated via the stored credential.

18. The apparatus of claim 15, wherein and the second information further comprises an indication of the account, and obtaining the credential that is associated with the one or more permissions is based at least in part on the account being granted the one or more permissions.

19. The apparatus of claim 15, wherein the first information is indicative of the plurality of capabilities, a plurality of endpoints from a plurality of APIs, a plurality of credentials, and content associated with the application, and the first information is usable by the first user to identify the application in the cloud platform and to determine the plurality of capabilities of the application.

20. A non-transitory computer-readable medium storing code for configuring and managing applications from a cloud platform over a duration of time, the code comprising instructions executable by one or more processors to:
determine first information for an application associated with a plurality of capabilities, wherein the first information is determined in accordance with an application specification template that is common to a plurality of applications, and wherein the first information is usable by the cloud platform for configuring and managing the plurality of capabilities via the cloud platform;
obtain second information from a first user of the cloud platform, wherein the second information comprises a first request to configure the application for an account of the application that is associated with the first user, and comprises a second request to configure a set of capabilities of the application, the set of capabilities selected from among the plurality of capabilities;
redirect the first user to authenticate the first user to obtain access to the application in accordance with an authentication flow for the application;
obtain third information in response to redirecting the first user, wherein the third information comprises a credential to authenticate with one or more application programming interfaces (APIs) related to the application, wherein the credential is associated with one or more permissions that enable the cloud platform to configure and manage the set of capabilities of the application for the account via a provider of the application; and
configure the set of capabilities in the application via one or more API calls from the cloud platform to one or more endpoints of the provider, wherein the one or more API calls are authenticated via the credential in accordance with the first information.
